(19) United States
(12) Patent Application Publication
(10) Pub. No.: US 2007/0009755 A1
(43) Pub. Date: Jan. 11, 2007

(54) Faux stainless steel and method of making

(76) Inventors: Roger Ben, Harmony, PA (US); Luis Saez, Chicago, IL (US)

Correspondence Address: William Squire, Esq.;c/o Carella, Byrne, Bain, Gilfillan,, Cecchi, Stewart & Olstein, 5 Becker Farm Road, Roseland, NJ, 07068, US

(21) Appl. No.: 11/221,300

(22) Filed: Sep. 7, 2005

Related U.S. Application Data
(60) Provisional application No. 60/697,344, filed on Jul. 7, 2005.

(51) Int. Cl. B32B 9/04; B32B 15/00; B05D 3/00; B05D 1/40

(52) U.S. Cl. 428/543; 428/626; 428/658; 427/331; 427/271

(57) ABSTRACT

A faux stainless steel sheet material preferably formed of a carbon sheet steel core coated with a metal zinc alloy, which may include zinc-aluminum with or without other minor elements or zinc-nickel compositions. The coating is polished in a polishing apparatus comprising a series of conventional polishing heads each of which utilizes a polishing belt of a predetermined grit mesh and size, belt speed, belt oscillations transverse to the sheet steel conveyed direction, at predetermined conveyance rate of the sheet steel and pressure. The polishing heads scratch the coating to a partial depth of the coating a portion of which remains after polishing. The scratches mimic stainless steel finishes which may include matte to bright silver blue and generally mimic a #4 stainless steel finish. Four polishing examples and four samples polished according to the examples are disclosed.

This application claims the benefit of application Ser. No. 60/697,344 filed Jul. 7, 2005 and incorporated by reference in its entirety herein.

This invention relates to providing a non-stainless steel substrate that has the appearance of stainless steel and a method of making.

Currently stainless steel for architectural applications, medical equipment, food industry equipment, sanitary equipment and so on is in wide use. Such finishes for home appliances and so on such as refrigerators, dishwashers, washing machines, ovens and the like are becoming popular and also are becoming widespread in use. Other finishes for such appliances typically are enameled and in some cases are finished in front with simulated wood grain panels and the like. Such finishes typically include enamel or other paint like finishes, which are less costly than stainless steel and are in wide use. One type of finish is a relatively low cost plastic laminate that simulates stainless steel for home appliance use. The problem with stainless steel material for such uses is its relatively higher cost.

Carbon steel sheet presently is finished to protect it from corrosion. Carbon sheet steel may also be coated with a metal coating as commercially available to protect it from corrosion. Such carbon steel coatings may include 80% zinc and 20% aluminum as provided by American Nickeloid Company (AN), 40-48% zinc, 51-58% aluminum, 1-2% silicon, 0.1-1% iron and <1% titanium as provided by international Steel Group (ISG) and 70-90-% zinc and 10-30% nickel as provided by Material Sciences Corp. (MSC). These coatings are applied to the base metal by hot dipping or electroplating. The coatings vary from about 0.0007 inches to 0.0015 inches thick on each side of the sheet. The metal coating is then finished with a clear coating. The clear coating is a polymer and protects the coated finish. This coated sheet material is less costly than stainless steel, but does not have the same high quality look and appearance of stainless steel.

The present invention is addressed to the problem of providing a carbon steel or other base material, preferably metal, but whether or not steel, that has a metallic finish and the appearance and look of stainless steel, but not the cost. Applicants are not aware of any non-stainless steel product that is metal and has the appearance and look of stainless steel. Such a non-stainless steel metal finished product would provide lower cost, but provide a quality appearance to various consumer goods such as the appliances and also would have wide architectural applications among others, for example.

U.S. Pat. No. 5,049,443 to Kuszaj et al. discloses a steel multi-layered composite molded structure. This is disclosed as a plastic backed enameled carbon steel or stainless steel finish product that has high impact, delamination and thermal shock resistance. The composite is formed of carbon steel or stainless steel and thus does not solve the problem noted above when using stainless steel. The carbon steel or stainless steel has a finish side of a shell layer of reinforced plastic bonded directly to the steel using silane to form a laminated structure. This patent is not directed to providing a substitute for the more costly stainless steel material and in fact may use such material in its structure.

U.S. Pat. No. 6,770,384 to Chen discloses an article coated with a multi-layer decorative and protective coating having the appearance of stainless steel. The coating comprises a polymer basecoat layer on the surface of the article and vapor deposited at a relatively low pressure on the polymer layer. A protective and decorative color layer comprises the reaction products of refractory metal or refractory metal alloy, nitrogen and oxygen wherein the nitrogen and oxygen content of the reaction products are each from about 4 to about 32 atomic percent with the nitrogen content being at least about 3 atomic percent.

US Publ. No. 2005/0040138 to Sato et al. discloses a surface finishing process for stainless steel where beautiful, bright and milky white colored surfaces are obtained for high carbon-containing 13 chromium steel and high sulfur-containing free cutting stainless steel. The surface is descaled first and then immersed into treating solutions. This process thus enhances stainless steel, but does not provide a substitute material that looks like stainless steel but does not have its cost.

U.S. Pat. No. 6,203,403 to Odstrcil et al. discloses a method for polishing stainless steel laminate press plates to produce a nondirectional, high gloss surface. This patent is not relevant to the problem of providing a low cost material that appears to have the finish of stainless steel.

A faux polished stainless steel sheet according to an embodiment of the present invention comprises a sheet material; a metal coating on a surface of the sheet material; and a polished finish on the exterior surface of the metal coating, which finish simulates polished stainless steel.

In one preferred embodiment, the coating is a metal alloy.

In a further embodiment, the sheet steel is a non-stainless steel metal and preferably is carbon steel.

In a further embodiment, the coating comprises an alloy of zinc having a composition in the range of about 40% to about 90% zinc with one of aluminum or nickel in the range of 20 to 58% aluminum and 10-30% nickel.

In a further embodiment, the coating comprises an alloy selected from the group consisting of one of 1) about 80% zinc and about 20% aluminum, 2) about 40-48% zinc, about 51-58% aluminum, about 1-2% silicon, about 0.1-1% iron and <about 1% titanium or 3) about 70-90% zinc and about 10-30% nickel.

Preferably, the coating has a surface roughness in the range of 8-48 Ra, scratches having a length in the range of about 3.18 mm (⅛ inches) to about 9.5 mm (⅜ inches), and a reflectivity of about 38 to 360 gloss units.

In a further embodiment, the coating surface has a reflectivity in one of the ranges of about 38-48 gloss units, 120-130 gloss units and 355-360 gloss units wherein a gloss unit is the ratio of light specularly reflected to the total light reflected wherein specularly reflected light is one wherein the angle of incidence equals the angle of reflection.

Preferably, the surface has scratches having lengths in one of the ranges of about 6.35 mm to about 9.5 mm (about ¼ to about ⅜ inches), about 9.5 mm to about 12.7 mm (⅜ to ½ inch), about 3.18 mm to 4.76 mm (about ⅛ to about 3/16 inches), and about 4.76 mm to about 6.35 mm (about 3./16 to about ¼ inches).

In a still further embodiment, the coating has a thickness of about 0.0051 mm to about 0.0254 mm (about 0.0002 to about 0.0010 inches).

In a further embodiment the coating finish has the appearance of a commercially defined abraded polished #4 stainless steel finish comprising 120-150 mesh wherein the term mesh refers to a belt grit value.

A method of producing a faux stainless steel sheet comprises coating a sheet material, preferably carbon steel, or other material, metal or non-metal, with a metal, preferably a zinc-aluminum alloy or a zinc-nickel alloy, and then polishing the metal alloy coating with an abrasive grit to mimic a stainless steel finish and, preferably, coating the coated sheet material with a clear protective coating such as a polymer or the like.

### IN THE DRAWING

FIGS. 1a and 1b together form a schematic diagram of a polishing line of a coil to coil polisher apparatus for polishing coiled sheet metal, FIG. 1b being a continuation of FIG. 1a at regions I-I;

FIG. 1c is a fragmented sectional elevation view of a carbon sheet steel with a metal coating prior to polishing;

FIG. 1d is a fragmented sectional elevation view of a clear coated finished coated carbon sheet steel after polishing;

FIG. 2 is a more detailed elevation view of a representative polishing head using a two roll polishing configuration employed in the polishing line of FIGS. 1a and 1b; and

FIG. 3 is a more detailed elevation view of a representative polishing head using a four roll polishing configuration employed in the polishing line of FIGS. 1a and 1b;

FIG. 4 is a fragmented side elevation view of a contact roll used in the apparatus of FIG. 1a and 1b; and

FIGS. 5a and 5b are graphs useful for explaining certain principals of the present invention.

FIGS. 6-16 are charts showing total and specular reflectance for polished stainless steel and the coated surfaces of samples 1-4 before and after polishing;

FIGS. 17-24 microphotograph side elevation sectional views of various samples with respective coatings on a carbon steel substrate showing coating thicknesses taken at 500× and showing the coatings before and after polishing according to the present invention;

FIGS. 25-29 are microphotographs at 50× magnification of the coated surfaces of samples 1-4 before and after polishing (FIGS. 25-27 and 28A) according to an embodiment of the present invention and a stainless steel reference sample (FIGS. 28 and 29);

FIGS. 30 and 31 are microphotographs at 500× magnification before polishing of the coated surface of sample 1;

FIG. 32 is a microphotograph of the coated surface of sample 1 before polishing and an overall elemental spectrum graph of that surface in the designated rectangular area of the microphotograph;

FIGS. 33-35 are microphotographs at 500× magnification of the coated surface of sample 1 before polishing and an elemental spectrum graph of that surface in the designated area of each microphotograph shown by the arrow including a chart showing the different compositions of the coatings at those respective locations;

FIGS. 36-37 are microphotographs at 3000× magnification of the coated surface of sample 1 before polishing and an elemental spectrum graph of that surface in the designated area of each microphotograph shown by the arrow including a chart showing the different compositions of the coatings at those locations;

FIG. 38 are two microphotographs taken with an ET detector and a BSE detector at 500× magnification of the coated surface of sample 2 before polishing;

FIGS. 39-42 are microphotographs at 500× magnification of the coated surface of sample 2 before polishing and an elemental spectrum graph of that surface in the designated area of each microphotograph shown by the arrow including a chart showing the composition of the coating at that location;

FIG. 43 is a microphotograph at 3000× magnification of the coated surface of sample 2 before polishing and an elemental spectrum graph of that surface in the designated area of the microphotograph shown by the arrow including a chart showing the composition of the coating at that location;

FIG. 44 are two microphotographs taken with an ET detector and a BSE detector at 500× magnification of the coated surface of sample 3 before polishing;

FIG. 45 is a microphotograph of the coated surface of sample 3before polishing and an overall elemental spectrum graph of that surface in the designated rectangular area of the microphotograph and a chart showing the composition of the coating in that area;

FIGS. 46 AND 47 are charts showing total reflectance of the coated surfaces of a reference stainless steel sample and the four samples 1-4 before and after polishing according to an embodiment of the present invention;

FIGS. 48 and 49 are charts showing specular reflectance of the coated surfaces of a reference stainless steel sample and the four samples 1-4 before and after polishing according to an embodiment of the present invention;

FIG. 50 is a graph showing total reflectance at 550 nm wavelength vs. no. of scratches per inch after polish of the four samples and of the stainless steel reference sample and for sample 2 before polishing according to an embodiment of the present invention;

FIG. 51 is a graph showing specular reflectance vs. no. of scratches per inch after polish of the four samples and of the stainless steel reference sample;

FIG. 52 is a graph showing surface roughness vs. no. of scratches per inch after polish of the four samples and the stainless steel reference sample;

FIG. 53 is a graph showing total reflectance at 550 nm vs. surface roughness after polish of the four samples and the stainless steel reference sample;

FIGS. 54-56 are graphs showing gloss of the four samples and of the SS reference sample measured respectively at 20, 60 and 85 degrees relative to the surface of the samples; and

FIGS. 57-58 are graphs showing L vs. surface roughness and vs. no. of scratches per inch respectively of the four samples after polishing and of the SS reference sample.

### DEFINITIONS

AP—After polish

Belt—A commercially available polyester backing to which grit has adhered. Size of belt (width) is not a factor in polishing metals.

Billy roll—A steel roll directly beneath and supporting the sheet steel being processed.

BP—Before polish

Color—The visual subjective appearance of the finish by the composition of a metal base coating on a substrate and possibly to a lesser extent by a clear coating applied over the base coating.

Coolant—A water soluble liquid applied to the belt at the polishing area. May have a minor effect on color of the finish. Coolant reduces friction from the abrasive grit laden belt, adds lubricity and contributes to more of a shiny, reflective surface.

Finish—The final condition of a surface after the last phase of production. A rougher finish generally means a more dull, grayish appearance on stainless steel as may be produced by a more aggressive grit such as aluminum oxide or zirconium as compared to silicone carbide. An aggressive finish, i.e., rougher, may appear to have a more silvery gray “wild” appearance due to its rougher condition and a less aggressive finish produced by smaller grit, e.g., silicone carbide, may appear to have a softer satiny darker finish. A smoother surface will be more reflective than a rougher surface.

#1 to #5 finish—A conventional finish applied to stainless steel (SS) as accepted as an industry wide standard.

#3 Finish—100 mesh intermediate used where a semifinished polished surface is sufficient as further finishing operations will follow fabrication.

#4 Finish—120-150 mesh applied to a preconditioned sheet using abrasive belts and lubricating oils. A uniform commercial finish used extensively in food, dairy and pharmaceutical process equipment, or anywhere a smooth sanitary appearance is desired. Architectural quality sheets are produced from suitable starting material with knowledge of end use details.

#6 Finish—This is a dull satin finish having lower reflectivity than #4. It is produced by tampico brushing #4 finished sheets in a medium of abrasive particles and oil. It is used where dull matte finishes are necessary.

#7 Finish—This has a high degree of reflectivity, produced with fine abrasives to 320 grit then using a heavy lubricant or buff to bring the finish to a semi-mirror without removing the grit scratches. It is used chiefly for architectural trim and ornamental purposes or special industrial applications where a very fine finish is required.

#8 Finish—This is the most reflective of the AISI/ASM finishes. It is obtained by polishing with successively finer abrasives and buffing extensively with very fine buffing rouges. The surface is essentially free of grit scratches from preliminary grinding. This finish is most widely used for architectural applications, press plate mirrors and reflectors.

Finish specifications—Standard finishes provided by ASM/AISA specifications available at www.ssina.com.

Standard 3A Finish—150-240 grit finish

Sanitary Finish #3—80-100 grit finish, Ra>/=40 microinches

Sanitary Finish #4-100-120 grit finish, Ra>/=25 microinches

Pharmaceutical Finish #7—Buff Finish (mirror like)

Pharmaceutical Finish #8—Buff Finish (mirror like)

Grit—particles, an abrasive particulate material typically silicone, aluminum oxide or zirconium, applied to a polishing substrate such as a conventional abrasive polishing belt. Expressed in terms of numbers. e.g., 80/120/150/180/220 and so on. The smaller the number the larger the grain size of the particles and the rougher the surface roughness. An 80 mesh is rougher than a 120 mesh. Representative grits include silicone carbide, aluminum oxide, and zirconium. Silicone carbide is preferred for the present invention as it breaks down during use and is not too aggressive and is used for standard finishing and polishing. Aluminum oxide is used for light grinding and finishing in some cases. Zirconium is used for heavy grinding and stock removal. Suppliers of such grits include the following companies: 3M, Norton, Hermes, VSM and Sancap.

Head pressure−Pressure load—Pressure of the polishing belt on the sheet metal being polished. Measured in terms of % load amperage on the belt drive motor. The higher amperage, the higher the pressure, the more aggressive the removal of material. Most motors idle at 20% load and polish stainless steel at about 75% load.

Head speed—The speed of the belt driven in the head by a drive roller.

Lightness L—Visual perception of the relative color and/or whiteness of a metal finish on a grayscale of black (0) to white (100).

Mesh—belt grit, e.g., 120-150 grit for silicone carbide grit.

Microinch—Root Mean Square divided by 1.11=one Microinch (one Microinch×1.11=RMS)

Polish—Providing an exterior surface finish to metal that changes its appearance by scratching the surface of the metal with fine grit to provide an aesthetic pleasing smooth and finished appearance to the exterior surface.

Polishing head—A set of two or four rolls about which a polishing belt is driven. In a two roll head, one roll is motor driven, is used to track the belt and is the belt driver and the other is a contact roll which is driven and which engages the polishing belt.

Ra or RA—Arithmetical average surface roughness. See FIG. 5a. Roughness average is the arithmetic average height of the roughness irregularities measured from a mean line within a sample length L. This parameter may be commonly referred to as “the finish.”

$$Ra = \frac{1}{N} {\sum }_{l = 1}^{N} Yi where Yi is the value of the profile deviations from the mean line over an evaluation length , not the sample length for ANSI$$

Rq-RMS—Root Mean Square surface roughness. See FIG. 5b. This is more sensitive to occasional peaks and valleys, making it a more valuable complement to Ra. While Ra is the arithmetic average, Rq is the geometric average height of the roughness component of irregularities measured from the mean line with the sampling length L. Rq is the square root of the arithmetic mean of the squares of profile deviations (Yi) from the mean line.

$$Rq = {( \frac{1}{N} {\sum }_{l = 1}^{N} {Yi}^{2} )}^{1 / 2} where Yi is the value of the profile deviations from the mean line over an evaluation length , not the sample length for ANSI$$

Scratch—A linear impression, i.e., a groove, in a surface having a depth, length, width and relative orientation to a substrate length. Not important, per se, in defining a finish, which is best determined by surface roughness Ra or Rq as defined herein and as produced by and manifested by an array of scratches.

Scattered reflection—The angle of incidence of light differs from the angle of reflection.

Specular reflection—Reflection of light where the angle of incidence equals the angle of reflection.

SS—Stainless steel

Surface Finish Roughness—Measured in RMS (root mean square) or Ra (average surface roughness). RMS is about 11% higher than Ra and typically is used as a measure of final finish rather than reflectivity to provide a quantified measure of the surface condition. The appearance of the surface finish to an observer is subjective and its appeal is correlated to surface roughness to assure repetitiveness.

Total reflectance—Specular and scattered reflection combined.

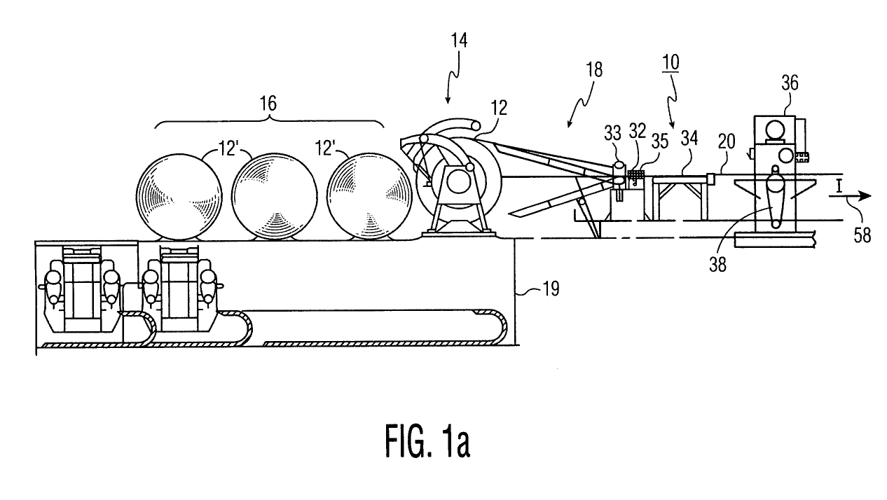

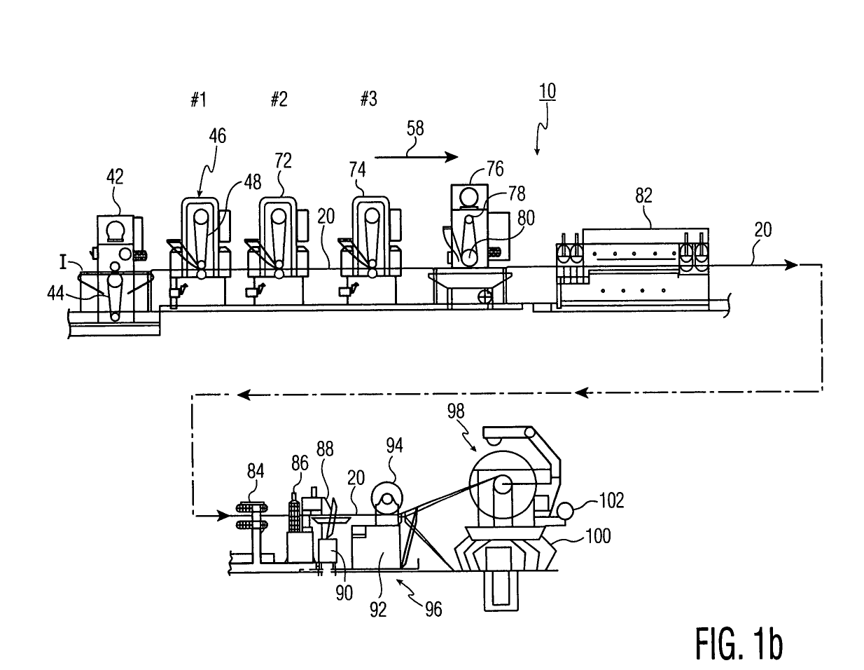

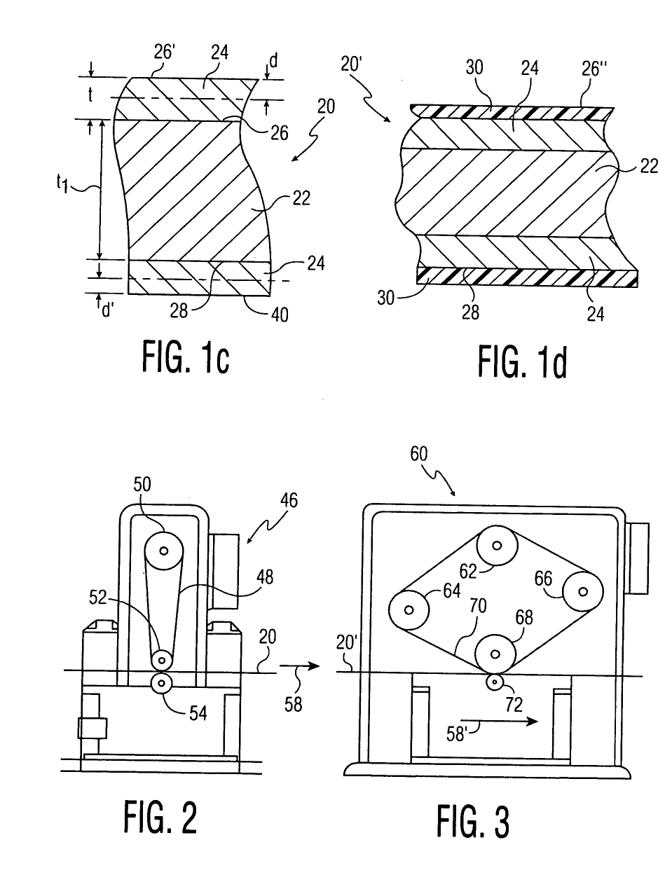

In FIGS. 1a and 1b, polishing apparatus 10 generally is conventional utilizing individual apparatuses that are conventional in the metal polishing art utilizing commercially available polishing belts that have associated grits. This however, is notwithstanding the fact that the combination of polishing belts, and corresponding mesh, belt pressure, speed, grit, time and depth of polishing and related polishing factors described hereinbelow are novel. The apparatus 10 comprises a plurality of polishing machines aligned in a linear array.

It is known, however, that every polishing apparatus comprising one or more polishing heads, even if otherwise identical from the same manufacturer, may produce a slightly different unique finish for a given set of variable factors. These factors, however, can be adjusted in each apparatus to produce substantially the same finish. Those variables that exhibit the least influence over finish include the type of polishing head, two or four roll, belt size, i.e., its width, the oscillation parameters of the belt, and the type of coolant.

Each of the polishing machines in the apparatus 10 cooperates with each of the prior and subsequent machines in a linear sequence to produce the finished product. This sequence polishes the metal coated steel sheet substrate material. This material is of conventional gauge and width, as used to finish the exterior surfaces of major appliances such as refrigerators, ovens, clothes washers and dryers, dishwashers and others or in architectural applications to provide the appearance of SS.

Such appliances or applications fabricated with conventional SS sheet metal exteriors are relatively costly and popular. It is believed by providing faux SS which is less costly than real SS, the cost of the related appliances can be reduced significantly and make such appliances available to a less affluent wider portion of the population. This is made possible to a population having less finance resources available for purchase of such appliances.

In FIGS. 1a and 1b, the sheet steel 20 is supplied from a coil 12 located at coil supply and uncoiling station 14. While coils are described as the form of the sheet material, it may be supplied in other forms, e.g., discreet sheets. Such sheets, which are not preferred for the present polishing invention, may be tack welded to each other during processing to form a continuous sheet. Also the coiled sheets are later, after polishing, cut into discreet sheets (not shown) according to a particular implementation.

Other coils 12′ of carbon steel sheet material await polishing as replacements for coil 12 in an array 16 on support 19 when the polishing of the coil 12 is completed. The coils 12, 12′ are stacked on support 19.

Station 14 comprises a conventional twin cone uncoiler 18, which uncoils the sheet steel 20 from the coil 12. A conventional arrangement is provided (not shown) which moves a new coil 12′ into the uncoiler 18 at station 14 when the current roll 12 being processed is emptied of sheet steel. The sheet steel 20 is then pulled through the remainder of apparatus 10 by a coiling station at the other end of the apparatus 10 for polishing.

The difference between apparatus 10 and a conventional stainless steel polishing system is that in a conventional system, the polishing operation is conducted on the base stainless steel sheet metal removing base material of the sheet steel. There is no coating on this sheet metal, and thus the amount of material removed by polishing is not critical. In the present apparatus, the base carbon steel substrate carrying a metal coating is not touched by the polishing heads, which only polish the coating to a fraction of the coating thickness. The coating is of limited thickness t, FIG. 1c, which is preferably about 0.01778 mm (0.0007 inches) to about 0.0381 mm (0.0015 inches) thick. Thus the removal of a fractional portion of the coating during polishing is much more critical than in polishing conventional SS having no such coating and a much thicker base metal than such a coating.

In FIG. 1c, the unpolished coated sheet steel 20 has a core 22 of conventional carbon steel and has a thickness t₁, as used in the appliances as noted above and other applications, such as architectural elements, automotive and aircraft components and so on. The coated steel sheets are preferably used in interior applications not subject to severe weather conditions. Exemplary thickness t₁, FIG. 1c, of the carbon steel sheet core 22 is about 0.4826 mm or about 0.762 mm (0.019 inch or 0.028/0.035 inch). A clear coating 30, FIG. 1d, is also preferably employed to protect the polished coating finish of surface 26″ of coating 24.

The core 22 has a metal zinc alloy coating 24 on all of its exterior surfaces including the core primary surface 26 and the core underside surface 28. Exemplary coating alloy compositions are shown in Table 1. The coating may be applied by electroplating, hot dipping or other known deposition processes not critical to the present invention. These processes are given by way of example and not limitation. Other coating compositions may be derived by one of ordinary skill. The importance of the composition is that it while it is not stainless steel, it provides the appearance of stainless steel when polished as described herein.

TABLE 1
METAL ALLOY COATING COMPOSITIONS RECEIVING
POLISHED FAUX STAINLESS STEEL FINISH

| | COMPOSITION | COMPOSITION | COMPOSITION |
|---|---|---|---|
| element | 1% | 2% | 3% |
| Aluminum | 20 | 51-58 | |
| Zinc | 80 | 40-48 | 70-90 |
| nickel | | | 1-30 |
| iron | | 0.1-1.0 | |
| Titanium | | <1 | |
| Silicon | | 1-2 | |

While coatings above are disclosed as metal alloys, non-alloy metals may also be used as a substrate coating. For example, zinc and other metals may be used as a coating without alloying the metal. The coating can be deposited by electroplating or by any other known deposition technique. One of ordinary skill using the techniques and principles disclosed herein can empirically develop the appropriate faux stainless steel finish with such coating metals.

The coating surface 26′, FIG. 1c, over the primary base metal carbon steel surface 26 is polished to a depth d having a value, for example in this embodiment, of no more than about 0.00762 mm (0.0003 inches) to about 0.0127 mm (0.0005 inches) such that a portion of the coating 24 remains. The polished surface 26″, FIG. 1d, has the appearance of SS. The polishing operation to remove such a minimal amount of coating is critical so that the base carbon steel core 22 is not exposed leaving a residual amount of coating 24. Yet this coating is required to exhibit minute scratches that mimic polished SS. Such SS may be polished to remove base material to a much greater depth than the polishing of the coating 24 to depth d, FIG. 1c. The polished coating 24 provides the faux stainless steel finished look to surface 26″ and thus to the sheet steel 20.

In FIG. 1d, a clear protective coating 30 is applied over both sides of the metal coating 24. The clear protective coating is not part of the present invention. The clear coating, which may have different compositions, is proprietary to various customers of the assignee of the instant invention receiving the finished sheet steel product. The clear coating is applied by them to the polished sheet material.

In FIG. 1a, downstream from the uncoiler 18 is an entry feed table 32 including an entry pinch roll 33 and an entry side guide 35. Downstream from the guide 35 is a weld table 34 for performing weld operations on the sheet material as deemed necessary. For example, the end edge of a sheet being processed is tack welded to the leading edge of the next to be polished coil sheet. Downstream from the weld table is a first polishing head 36. This head 36 may include an abrasive polishing belt 38, which belt includes an appropriate abrasive mesh attached, and which can be used to polish the underside surface 40 of the coated sheet steel 20, FIG. 1c, in a bottom surface polishing stage. However, in the present embodiment belt 38 is not in place or used. The underside of the sheet steel 20 is preferably not polished in this implementation.

In FIG. 1b, downstream is a second bottom polishing belt 44 (not used in the current process) and identical to the belt 38. The steel 20 bottom surface may optionally have a final faux SS finish if desired the same as surface 26″, FIG. 1d. In the alternative, if for some reason the initial top surface finish becomes defective during processing, the bottom surface can then be finished as a faux stainless steel finish.

In FIG. 1b, apparatus 10 includes a first faux SS polishing head 46 having an abrasive polishing belt 48. The head 46 has a two roll configuration. FIG. 2 shows a more detailed illustration of the two roll configuration of representative head 46. The head 46 comprises an upper drive roll 50 and a small diameter lower driven roll 52, referred to as a contact roll in this art, which together drive the grit laden belt 48.

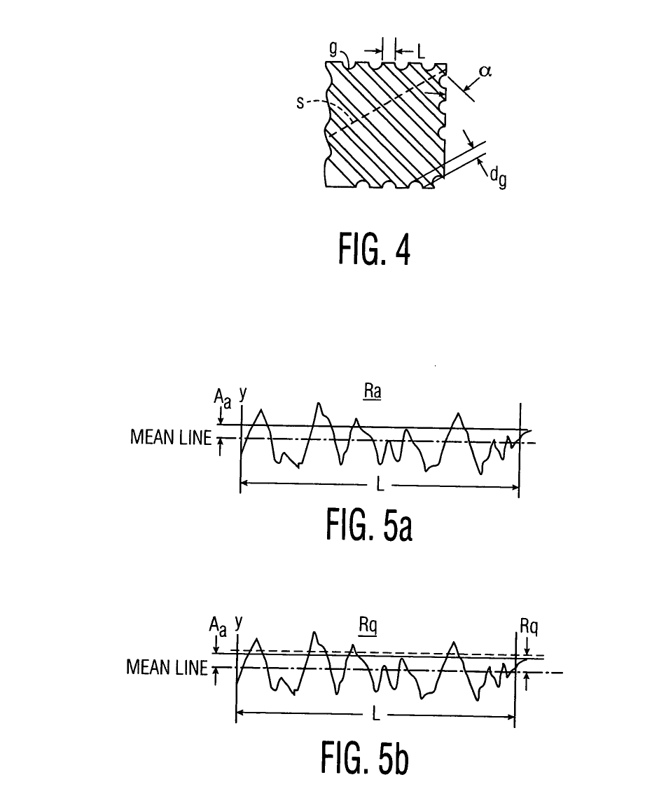

The roll 52, which is representative of other contact rolls used in the apparatus 10, is shown in FIG. 4. The roll 52 is made of rubber, and has the parameters noted in Table 2 below. The land in the Table is dimension L, the groove is groove g in FIG. 4, the angle of the grooves to a circumferential direction is α and the depth of the groove g is dimension d_{g}. The durometer is the hardness of the material and is significant in the final finish parameter affected by the roll. The significance of the groove g, its depth dg, its angle α and the width of the land L between the grooves, the roll diameter and its durometer is as follows.

The contact roll 52 is important in the finishing process. The contact roll serves the purpose of causing the coated belt to perform as if rigid and the abrasive particles on the belt to act as a group of sharp cutting teeth. It is an instrument that makes close and precision tolerances on thin carbon steel and coated sheets possible. Also, other parameters of the finishing process can influence the finishing process performed by the abrasive belts, there may be no optimum contact roll design for any given application. However, a discussion of the causes and effects provide guidance to select the contact roll parameters is appropriate for the processing of the coated sheet steel according to an embodiment of the present invention.

Some of the issues involved are whether the process is wet as in the present embodiment, or dry. The rate of stock removal, tolerances and finish requirements also play a part in specifying the contact roll parameters. In a wet process, the type of oil or water soluble fluid, i.e., the coolant, and the chemical additives are beneficial to insure against deterioration and softening of the roll in use. The contacts rolls need to be dynamically balanced at the RPM of use to insure minimum vibration or other undesirable results in an unbalanced roll.

Roll hardness is commonly measured by indentor type gauges that are calibrated in the “A” scale (ASTM D2240 and MIL-T-45186). The range of this scale is 0 to 100, with lower numbers (50 and lower) indicating a relatively soft condition and higher numbers (higher than 50) indicating a relatively hard roll. The durometer tolerance is typically +/−5. Soft durometers are used where stock removal is not of prime concern. Such rolls will conform to tapered or crowned sheet material without scalping and are also used to generate fine finishes. Harder durometers are used for heavy stock removal and thus are not desirable for the present process, which is directed to removing a minimum amount of coating to thereby polish the coating to the desired finish.

The land to groove ratio is important to minimize and avoid chatter. Such ratios should not exceed 1:1 to minimize such problems. Grooves are preferably used to minimize contamination, i.e., oil, dirt etc. If the roll face becomes contaminated, objectionable marking and streaking of the roll surface (the land areas) may occur with the use of fine grit belts. The grooves preferably should be formed with a radius at the root to provide more support for the individual lands to prevent fatigue and subsequent premature breakage of the land areas.

The roll groove angle α, FIG. 4, has a possible range of 0 to 90°, but such a wide range is not used. The preferred range of the angle α is between a minimum value of about 8° and a maximum practical angle of about 60°. The 8° value provides a better finish than polishing with the 60° angle and is less aggressive. In the present process, however, the groove has a preferred angle of 45°. The 60° value is the maximum aggressive abrasion that results in a poor finish where that is acceptable and is not used with the present process for obvious reasons.

Any value less than 8°, e.g. 0° is not usable because striping or streaking occurs in the finish. More than 60°, for example 90°, is not usable because it results in excessive pounding, chatter, vibration and premature product destruction. The values between 0° and 8° increases the striping or streaking so that the finish is undesirable or values between 60° and 90° results in increased undesirable pounding, chatter, vibration as the value approaches 90°. For the present process, the roll groove angle is preferred at about 45°. As the need for uniform, mark free finishes increases as in the present embodiment, the angle of the grooves, which form serrations, decreases. No grooves or serrations are used where mainly polishing and fine finish generation is desired using soft 25-50 durometer contact rolls and where stock removal is minimal. As a result, to finish a coating as described herein uses a 50 durometer contact roll.

Contact rolls may be urethane as well as rubber compounds. A rubber compound is preferred for the contact rolls for the present apparatus 10. Hardness can range from 25 Shore A durometer (very soft) to 95 shore A durometer (very hard). The preferred durometer in the present process is shore A 50. The preferred grit is silicone particles. The contact roll among other factors in the process are described further in Table 2 below.

The belt 48, as all of the polishing belts used in the apparatus 10 polishing heads, has a width normal to the drawing figure of about 1.32 m (about 52 inches) whereas the sheet steel 20 substrate has a width of about or less than 1.219 m (48 inches). Directly beneath the lower roll 52 and beneath the sheet steel 20 being processed is a support billy roll 54. The relative vertical position of roll 54 is adjusted by a crank (not shown) to apply the pressure to the roll 52, the belt 48 and to the sheet steel 20 between the two rolls during polishing.

The head pressure is measured as a function of the load amperes drawn by the drive motor in the head. See Table 2 for exemplary pressures in the examples shown. Roll 54 supports the sheet steel 20 as it is conveyed through the station 46 as well as applies pressure. Abrasive belt 56, laden preferably with silicone grit, but could be grit of other material as well, is driven by roll 50 via a motor (not shown).

In addition, an oscillating mechanism (not shown) oscillates, by a pivoting action, the upper drive roll 50 to displace the belt 48 at the drive and belt tracking roll 52. The belt 48 is displaced in a direction normal to the feed direction 58 of the sheet steel 20 in and out of the drawing sheet perpendicular to the drawing sheet. The upper roll 50 is oscillated to thus reciprocate the belt 48 in directions normal to directions 58 preferably about 1.27 cm to about 2.54 cm (about ½ inch to about 1 inch). This motion transfers oscillating transverse motion amplitude to the belt 48 passing about the driven contact roll 52 of about 1.27 cm to about 2.54 cm (½ to about 1 inch) in the direction normal to direction 58. Thus as the coated sheet steel 20 is pulled in direction 58, the belt 48 is oscillating in a normal direction at its sheet steel 20 contact region at the above amplitude. The values of grit size, belt speed, contact roll pressure, feed rate of the sheet material determine the finish characteristics on the coating 24 producing surface 26″ in cooperation with the downstream steps described below and in Table 2. However, the variables that have the most effect on the finish are the type of belt (the grit) and head pressure. Too much pressure or a too aggressive belt can readily polish through the coating.

Lighter gauge sheet material is run through the apparatus at a higher rate than thicker gauges. Heat is built up by the polishing process. Such heat can warp the sheet steel by inducing center buckling or edge waves. The coolant can prevent this action, but too much dwell of the coating at the belt can pose a risk of too much coating removal. This result is much more prevalent when run without a coolant. The final result can be achieved by trial and error within the skill of those of ordinary skill in this art. Where the finish appearance is desirable, it is possible to run both thicker and thinner gauges at the same speed through the apparatus by careful attention to the parameters.

Belt widths for sheet steel of 48 inch widths or smaller may be 52 inches. Polishing may occur with 60 inch wide sheet steel using a belt of 62 inch width. The length of a belt is a function of the number of rolls in a head. A belt typically has a seam S diagonally across the belt width. This seam S, FIG. 4, represented by a phantom line, is non-parallel to and transverse a maximum amount to the contact roll grooves g to preclude belt damage during operation.

The faster the line speed, i.e., the speed at which the sheet steel 20 is pulled by the take up recoiler 98, the longer the scratch, i.e., the longer the section of the sheet steel that is contact with the grits as it passes beneath the contact roll. The faster the head speed the shorter the scratch. The faster the oscillations of the belt, the shorter the scratch. The oscillations provide the scratches of limited length. Otherwise, without the oscillations, the scratches would be continuous and not desirable.

An adjustment apparatus (not shown) in head 46, which is conventional as is the head 46 in general, adjusts the vertical position of the lower support roll 54 toward and away from the sheet steel 20. This applies the pressure of the conveyed substrate sheet steel 20 against the belt 48 at the position of the contact roll 52. The lower support roll 54 is referred to in this art as a “billy roll.” The amount of pressure on the belt 48 is measured by the current amperage value drawn by the roll 50 drive motor (not shown). In the same context, the so called billy roll 72 in head 60, FIG. 3, is adjusted vertically toward and away from the sheet steel 20 to move the sheet steel toward and away from the belt 70. This adjusts the pressure of the belt 70 on the sheet steel 20. The current amperage drawn by the drive motors for rolls is correlated to pressure. Generally, a correlation table may be utilized to correlate drive motor amperage to pressure of the belt on the conveyed substrate being polished, the sheet steel 20.

In FIG. 3, there is shown a four roll head (not shown in FIGS. 1a and 1b) which may be used in place of the two roll head 46 of FIG. 2, and which may be used in certain of the inventive processes as described below in Table 2. This table shows a set of examples provided for illustration and not limitation of the inventive process. For example, different polishing lines may be set up with different polishing heads according to a particular coating of the different coating compositions in Table 1. These polishing heads may be set up with different factors as discussed below in connection with Tables 2 and 3. One set of polishing heads may be used for one finish and one coating and another set of polishing heads may be used for a different finish on a second different coating and so on.

In FIG. 3, polishing head 60 comprises four rolls 62, 64, 66, and 68. Rolls 62, 64 and 66 are preferably the same size and roll 68, the contact roll, is somewhat smaller in diameter. Polishing belt 70 is driven by drive roll 64 whose amperage is a measure of the pressure on the contact roll 68. Roll 62 is a tracking roll and is rotationally oscillated to reciprocate the belt 70 at roll 62 in a direction normal to feed direction 58′ of the sheet steel 20′ being polished in this embodiment. Roll 66 is an idler. The amplitude of the oscillations induced by roll 62 at the belt 70 contacting the sheet steel 20′ is about the same as described above for head 46, but may differ in other processes providing a faux SS finish to a metal coating on carbon steel (or other substrate which may be non-metal or another metal) in accordance with a given implementation and as shown in Table 2.

A support roll 72, the billy roll, is beneath the sheet steel 20′ being conveyed and beneath and aligned with the roll 68 for applying pressure to the conveyed sheet steel 20 against roll 68. An adjustment apparatus, a crank (not shown), adjusts the vertical position of billy roll 72 to apply pressure against the sheet steel 20′ and the belt via the vertically aligned contact roll 68 of the head 60. Not shown in FIGS. 2 and 3, is a speed adjustment control which may not be present on all heads for setting the speed of the drive rolls 50 and 64 and thus the speed of the polishing belts 56 (FIG. 2) and 70 (FIG. 3). The amplitude and frequency of the oscillations of the rolls 50 and 62 of heads 46 and 60, respectively, is also settable by controls (not shown) and which controls are conventional. The belt 70 thus oscillates in the oscillation range of the belt 56, FIG. 2, as described above and as detailed in Table 2.

Not shown in the figures is a coolant supply apparatus which supplies coolant to the belt before, at and after the polishing. The supply apparatus is conventional as supplied by the manufacturer of this machine. The coolant floods the polishing region between the belt and the sheet steel 20. The coolant may be Castrol Syntilo 9730, a product of Castrol company for a synthetic cutting fluid as used in the metal cutting art. The fluid comprises ethanol 2,2′,2″-nitrilotris (10-15% by weight), 1-propanol, 2-amino-2 methylborax (5-10% by weight) and 1,2-ethanediamine (0.1-1% by weight). An alternative coolant may be 4278 Chemtool, a product of the Chemtool company. This is a synthetic metal cutting fluid comprising ethanol 2,2′,2″-nitrilotris (10-15% by weight), hexanoic acid, 3,5,5-trimethy (5-10% by weight) and ethanol, 2-amino (1-5% by weight).

The apparatus 10, FIGS. 1a and 1b, is shown only with the two roll polishing heads of FIG. 2 as an example for one polishing process. However, as shown in Table 2, four roll polishing heads may also be used. Some of the polishing heads depicted in FIGS. 1a and 1b are not in use in the present finishing process, but may be used in future or for other different processes, not described herein, employing the principles of the present invention.

In FIG. 1b, further two roll polishing heads 72 and 74, identical to head 46 are downstream from head 46. A further head 76, different than heads 46, 72 and 74 (not used in the present embodiment) is downstream from head 72. Head 76 has a relatively small drive roll 78 and a larger diameter contact roll 80.

Immediately downstream from head 76 is a conventional hot water rinse station 82. This station is followed by a drying station 84 for drying the sheet steel 20 being processed and followed downstream by an exit pinch roll 86. This is followed by an exit cropping shear station 88 and associated scrap buggy 90. Next in the line is an optional edge guide 92 and a turn roll 94 which deflects the sheet steel 20 to provide tension on the sheet steel 20 and exit feed table 96. These are followed by a recoiler 98 for coiling the processed sheet steel 20, a coil car 100 for receiving the coil of polished steel 20 and a paper unwind unit 102. The paper of unit 102 is interleaved with the coiled finished sheet steel 20 for protecting the polished finish surface. The polished finished surface is later protected by a clear coating as noted above and not applied by the apparatus 10. The clear coating protects the polished metal coating finish from scratches, scuffs, fingerprints and so on.

The polished coating finish is more critical than a standard SS finish. If the standard SS finish is not acceptable, the sheet material can be run through the polishing operation again as the finish is being applied to the thicker base SS metal. In the present novel process the finish is being applied to a relatively thin coating. If the finish is not acceptable, there will not be enough coating material left to redo the finishing process requiring another coating to be applied, which is costly and defeats the purpose of providing a low cost faux SS finish. In this case, the back side of the sheet steel which is not polished can be used to provide a second chance to polish the same coil.

In an alternative, a four roll head process utilizing the four roll head 60, FIG. 3, may replace each of the polishing heads 46, 72 and 74, FIG. 1b. The parameters for the alternative exemplary four roll head process are given in Table 2 below.

TABLE 2
(EXAMPLES)
Processing Parameters for Different Coatings and Different Polishing Heads

| | | Examples | | | |
|---|---|---|---|---|---|
| | | 1 | 2 | 3 | 4 |
| Coating | | composition 1 | composition 2 | composition 3 | composition 3 |
| see Table 1 | | | | | |
| polishing | | Mattison* | Hill Acme* | Hill Acme* | Hill Acme* |
| heads | | 456 | two roll | two roll | two roll |
| | | four roll | | | |
| polishing | 1^{st} head | VSM*CK721 | 3M* 461F | Sancap* | Sancap* |
| belt | | X EBRV07 | 180 grit S/C | C770 320 | C770 320 |
| | | 320 grit | | grit S/C | grit S/C |
| belt | 2^{nd} head | VSM*CK721 | not used | Sancap* | Sancap* |
| | | X EBRV07 | | C770 320 | C770 320 |
| | | 320 grit | | grit S/C | grit S/C |
| belt | 3^{rd} head | VSM*CK917 | 3M* 461F | Sancap* | Sancap* |
| | | X EBRV07 | 180 grit S/C | C770 320 | C770 320 |
| | | 800 grit | | grit S/C | grit S/C |
| belt size | 1^{st} head | 52 inch × 243 | 52 inch × 126 | 52 inch × 126 | 52 inch × 126 |
| | | inch | inch | inch | inch |
| belt size | 2^{nd} head | 52 inch × 243 | 52 inch × 126 | 52 inch × 126 | 52 inch × 126 |
| | | inch | inch | inch | inch |
| belt size | 3^{rd} head | 52 inch × 243 | 52 inch × 126 | 52 inch × 126 | 52 inch × 126 |
| | | inch | inch | inch | inch |
| line speed | | 28.96 m/min | 45.72 m/min | 30.48 m/min | 30.48 m/min |
| thickness t₁ = 0.4826 mm | | (95 ft/min) | (150 f/min) | (100 f/min) | (100 f/min) |
| (0.019 inch) | | | | | |
| line speed | | 24.38 m/min | 45.75 m/min | 30.48 m/min | 30.48 m/min |
| thickness t₁ = 0.76 mm | | (80 f/min) | (150 f/min) | (100 f/min) | (100 f/min) |
| (0.030 inch) | | | | | |
| Head Speed | 1^{st} head | 1893 | 900 | 1860 | 1200 |
| RPM | labeled #1 in | | | | |
| Head Speed | 2^{nd} head | 1820 | N/A | 1860 | 1200 |
| RPM | labeled #2 in | | | | |
| Head Speed | 3^{rd} head | 1140 | 900 | 1860 | 1200 |
| RPM | labeled #3 in | | | | |
| Head | 1^{st} head | 70% | 60% | 55% | 55% |
| Pressure | | | | | |
| Load % | | | | | |
| Meter | | | | | |
| | 2^{nd} head | 70% | 60% | 60% | 60% |
| Coating | | | | | |
| see Table 1 | | composition 1 | composition 2 | composition 3 | composition 3 |
| Head | 3^{rd} head | 60% | 60% | 55% | 55% |
| Pressure | | | | | |
| Load % | | | | | |
| Meter | | | | | |
| Oscillation | stroke length | 0.750 inches | 0.250 inches | 0.250 inches | 0.250 inches |
| (all heads) | | | | | |
| Oscillation | stroke rate | 55 cycles/min | 45 cycles/min | 45 cycles/min | 45 cycles/min |
| (all heads) | | | | | |
| coolant | | Castrol | 4278 | 4278 | 4278 |
| | | Syntilo 9730 | Chemtool | Chemtool | Chemtool |
| | | Castro | Cobalt Blue | Cobalt Blue | Cobalt Blue |
| | | Inhibitor #3 | 5% | 5% | 5% |
| Contact | Outside | 22.86 cm | 22.86 cm | 22.86 cm | 22.86 cm |
| Rolls Roll 52 | Diameter | (9.00 | (9.00 | (9.00 | (9.00 |
| | (OD) | inches) | inches) | inches) | inches) |
| Roll 68 | | | | | |
| | Durometer | 50 +/− 5 | 50 +/− 5 | 50 +/− 5 | 50 +/− 5 |
| | Land | 12.7 mm | 15.875 mm | 15.875 mm | 15.875 mm |
| | | (0.5 inches) | (0.625 | (0.625 | (0.625 |
| | | | inches) | inches) | inches) |
| | Groove | 9.53 mm | 9.53 mm | 9.53 mm | 9.53 mm |
| | | (0.375 | (0.375 | (0.375 | (0.375 |
| | | inches) | inches) | inches) | inches) |
| | Depth | 9.53 mm | 9.53 mm | 9.53 mm | 9.53 mm |
| | | (0.375 | (0.375 | (0.375 | (0.375 |
| | | inches) | inches) | inches) | inches) |
| | | radius | radius | radius | radius |
| | | bottom | bottom | bottom | bottom |
| | Degree of | 45 left hand | 45 left hand | 45 left hand | 45 left hand |
| | cut | helix | helix | helix | helix |

*manufacturer of head

Characteristics of Surface Finishes of Sheet Metal

Surface roughness—Measured with a profilometer and measures roughness average (Ra or RA). A reading of 45 or above may be considered rough and anything less is considered smooth. The lower the reading the smoother the finish.

Length of scratch—This is the average length of the scratch polished into the surface by an abrasive belt. This is typically measured manually.

Color—a comparative subjective description of the color of the finish.

Reflectivity—This measurement is not typically used for polished finishes because these finishes are generally not reflective (as in mirror finishes), but are more muted. Reflectivity is measured for the above examples to assist in quantifying the finishes. A reflectometer instrument measures reflectivity in gloss units (gloss units reflected into the instrument by the surface in question.). A reading of 500 gloss units or greater may be considered reflective where any value less than 500 gloss units might be termed muted. A glass mirror measures 1000 gloss units. Correlation of reflectivity to scratch length or scratch orientation is not known but is measured in certain of the samples corresponding to the examples given herein. Scratch length or scratch orientation is intended herein to only quantify the mechanical finish characteristics associated with the faux coated stainless steel desired finish.

See Table 3 as follows for finish characteristic factors.

TABLE 3
Parameters which effect the final finish characteristics.

| | |
|---|---|
| 1. | Surface roughness (RA) - Belt type, belt grit, contact roll and |
| | head pressure |
| 2. | Length of Scratch - Line speed, head speed and oscillation of the |
| | belt |
| 3. | Color - coolant, belt type and belt grit |
| 4. | Reflectivity - Belt type, belt grit, contact roll, head pressure and |
| | coolant |

The following Table 4 illustrates a comparison of the four faux finishes of the examples of Table 2 above using the quantifying values of Table 3 to provide approximate values.

TABLE 4

| | Example 1 | Example 2 | Example 3 | Example 4 |
|---|---|---|---|---|
| Surface | 12-16 | 40-48 | 8-18 | 8-18 |
| Roughness | | | | |
| (Ra) | | | | |
| Length of | 6.35-9.53 | 9.53-12.7 | 3.18-4.76 | 4.76-6.35 |
| Scratch | mm | mm | mm | mm |
| | (¼-⅜ | (⅜-½ | (⅛- 3/16 | ( 3/16-¼ |
| | inch) | inch) | inch) | inch) |
| Color | matte gray | silver gray | silver blue | bright blue |
| (by eye) | | | | |
| Reflectivity | 38-48 | 120-130 | 335-360 | 335-360 |
| (gloss units) | | | | |

The preferred finish applied to the coating is referred to in this art as a #4 stainless steel finish. The finish can be different and provided from industry standard finishes #3, #4, #6, #7 and #8 for which ASM/AISI specifications are written. See the introductory portion for further explanations of these finishes and also to the finishes described in the referred to Designer Handbook of Special finishes for Stainless Steel at the web site noted in the introductory portion. This document illustrates a wide variety of finishes that can be applied to stainless steel notwithstanding the standard finishes described above.

In polishing the coating, all preferred factors as follows contribute to the look of the finish. It should be also understood that the final look or appearance is provided by the clear coating.

| | |
|---|---|
| Head belt | See Table 2 for general applicable ranges |
| drive roll RPM | |
| Grit size | Finishing is 8-120 and grinding with aggressive defect |
| | removal is 24-60 grit. |
| Feed rate | 18.29-30.48 m (60-100 feet) per minute |
| Belts | Three top side |
| Pressure Load | 75 to 85 amperes. |

In the following description four samples are described that were produced generally in accordance with examples 1-4 and compared with a conventional stainless steel sample, all intending to simulate a # 4 stainless steel polished finish.

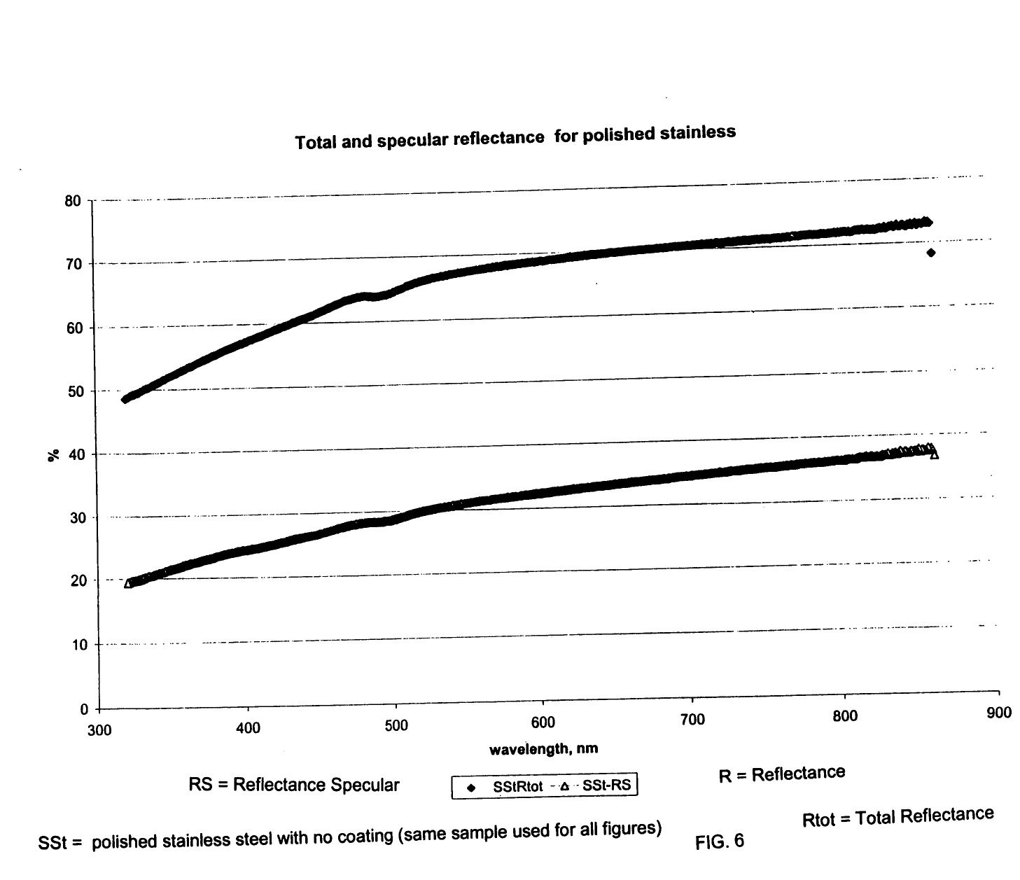

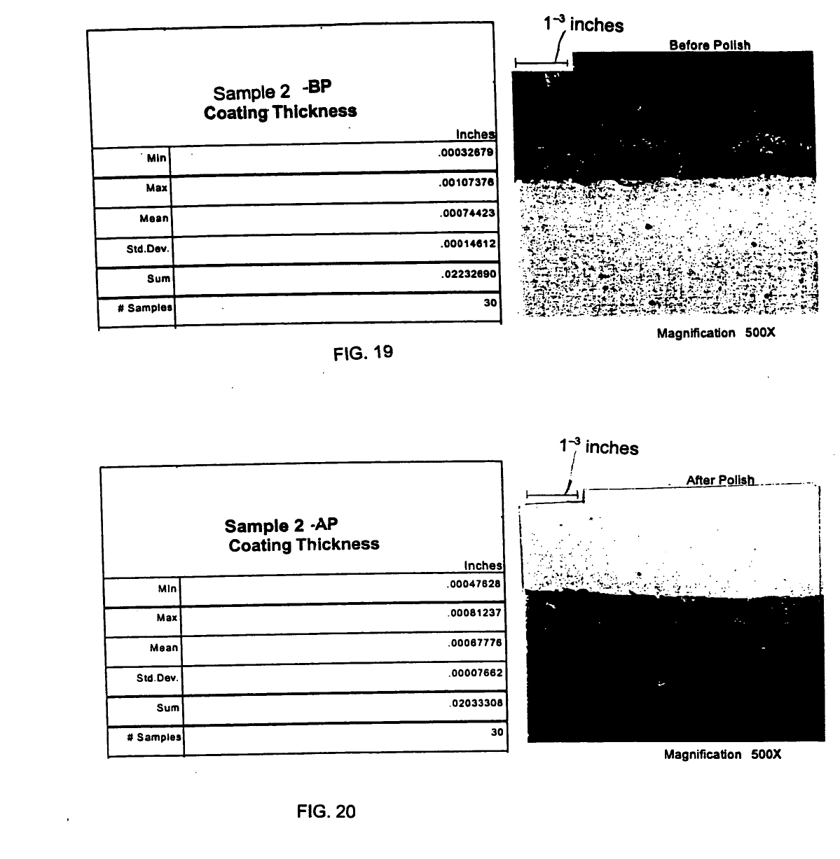

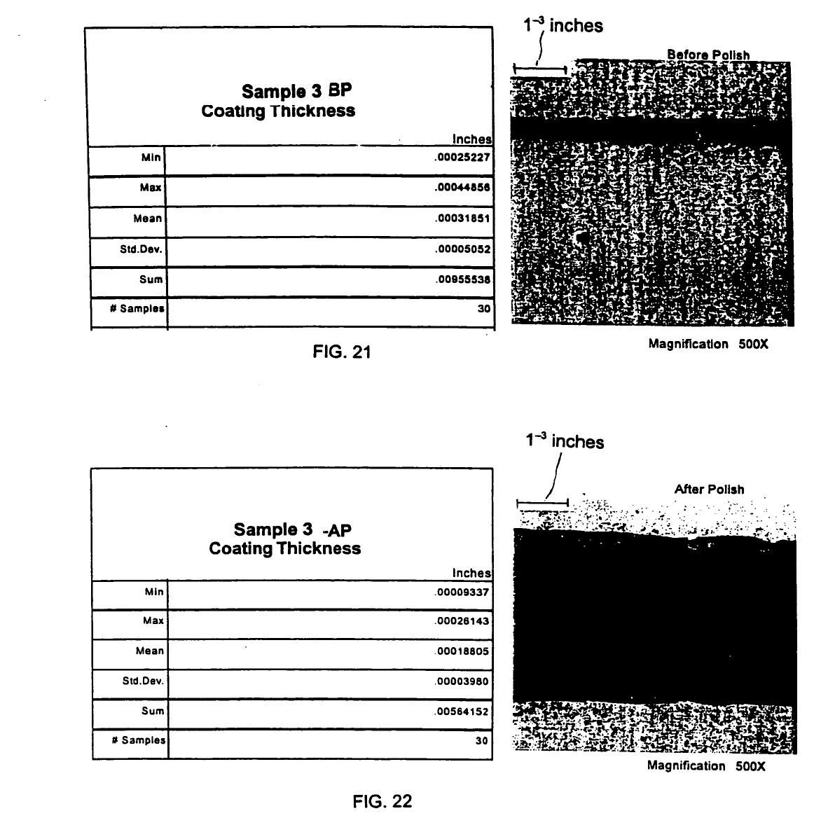

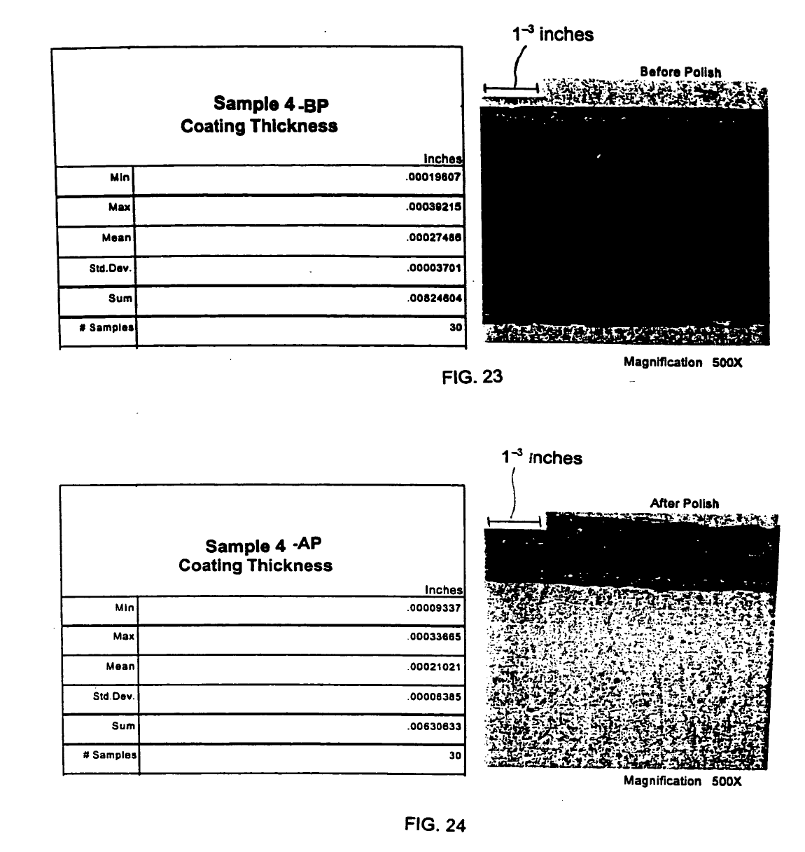

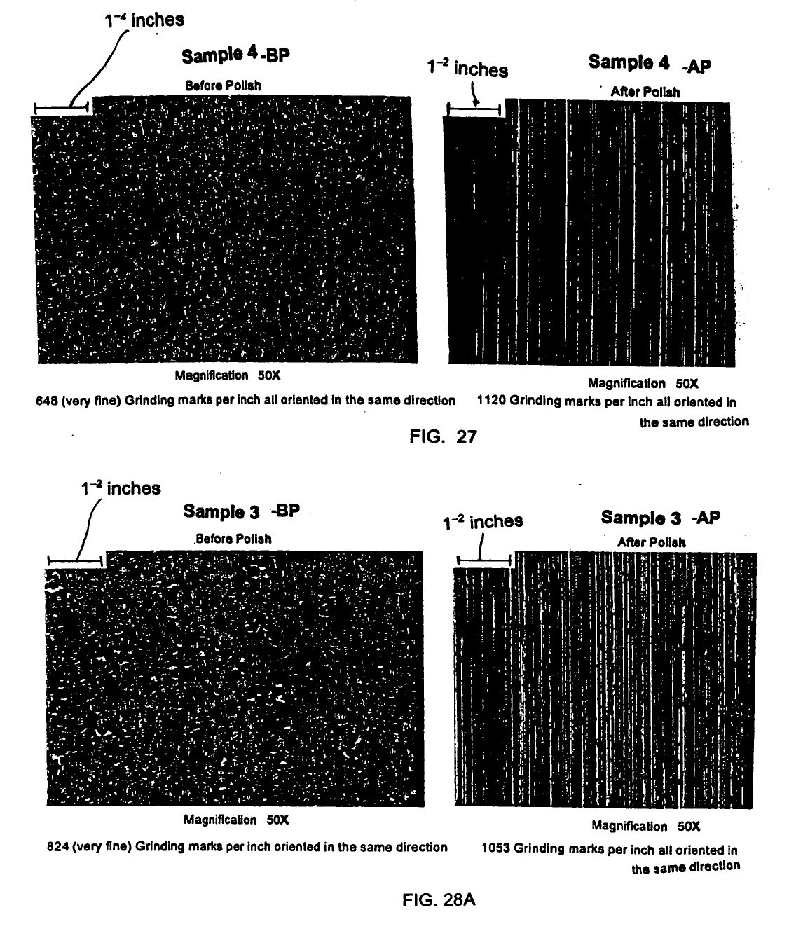

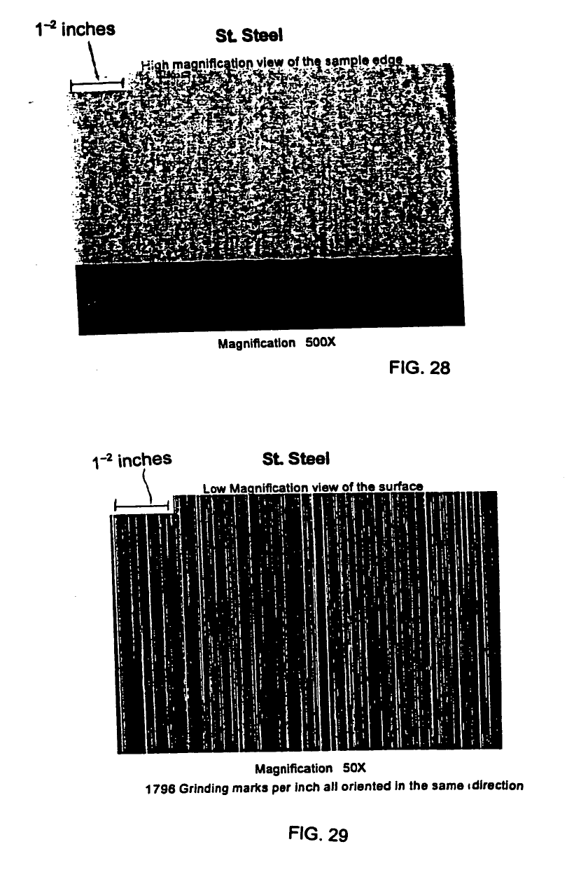

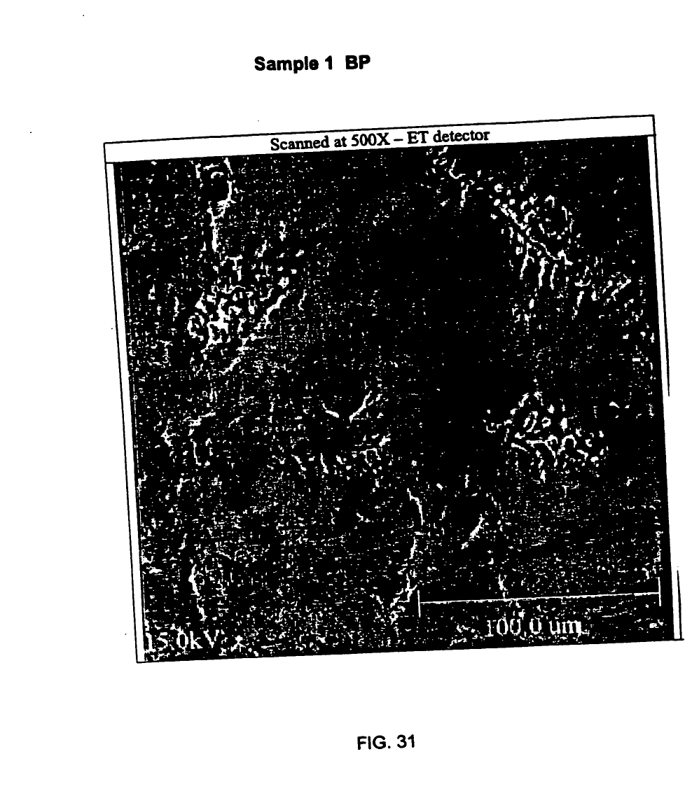

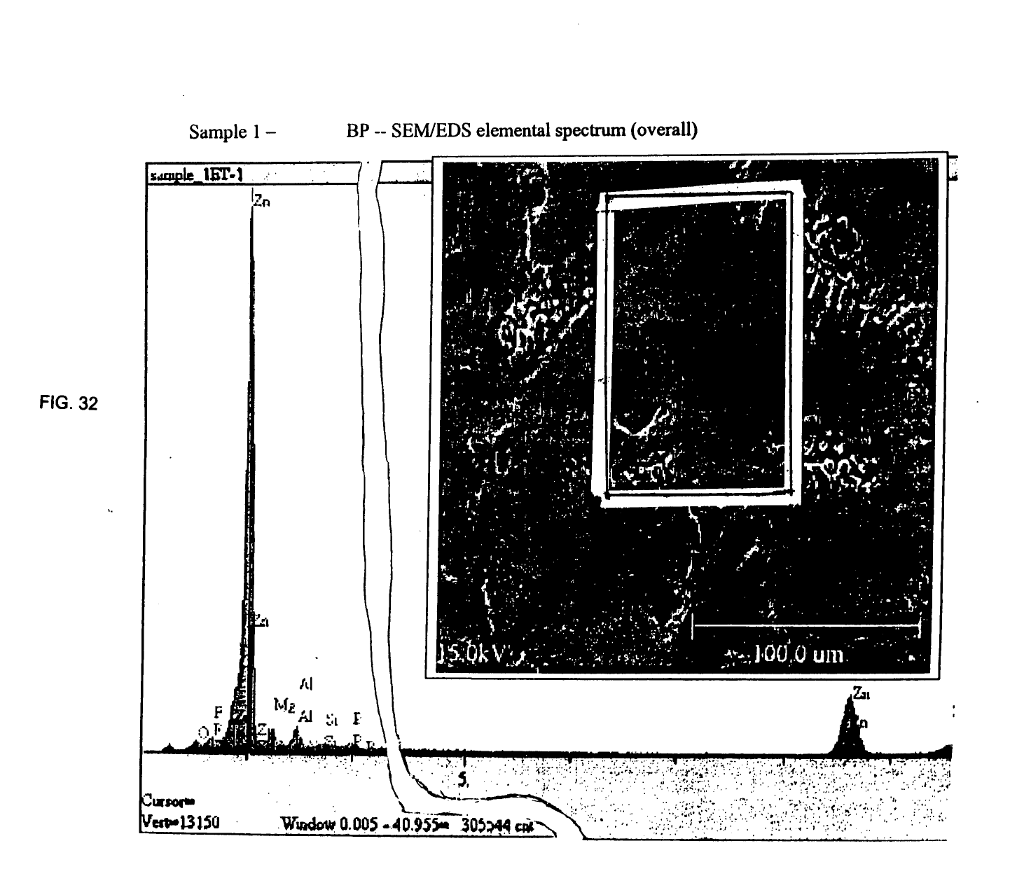

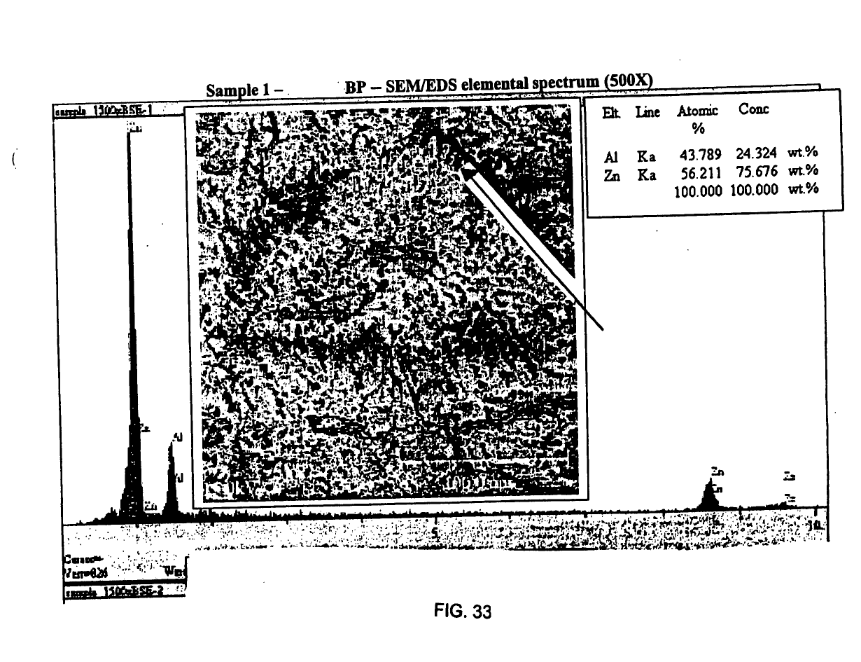

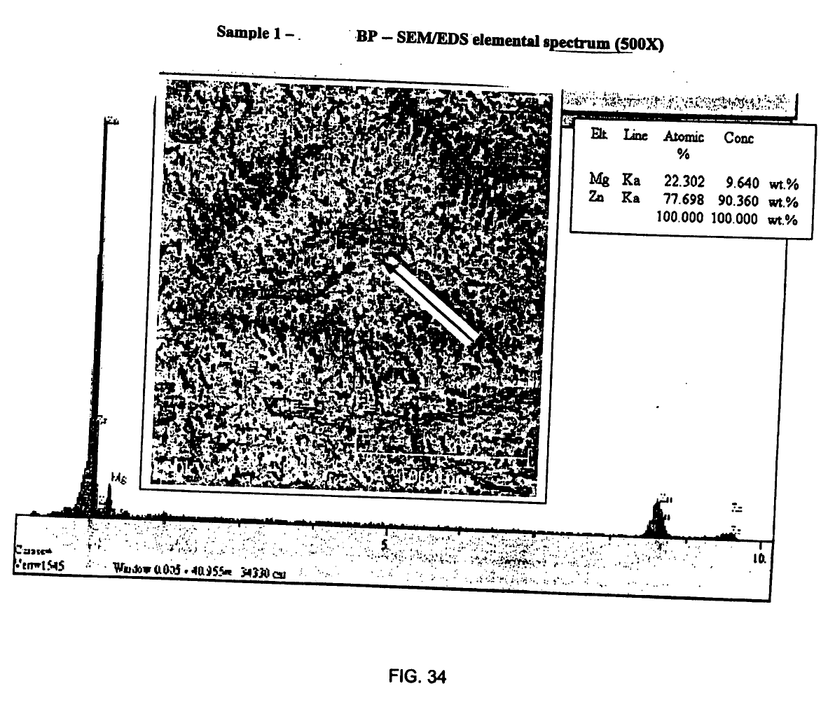

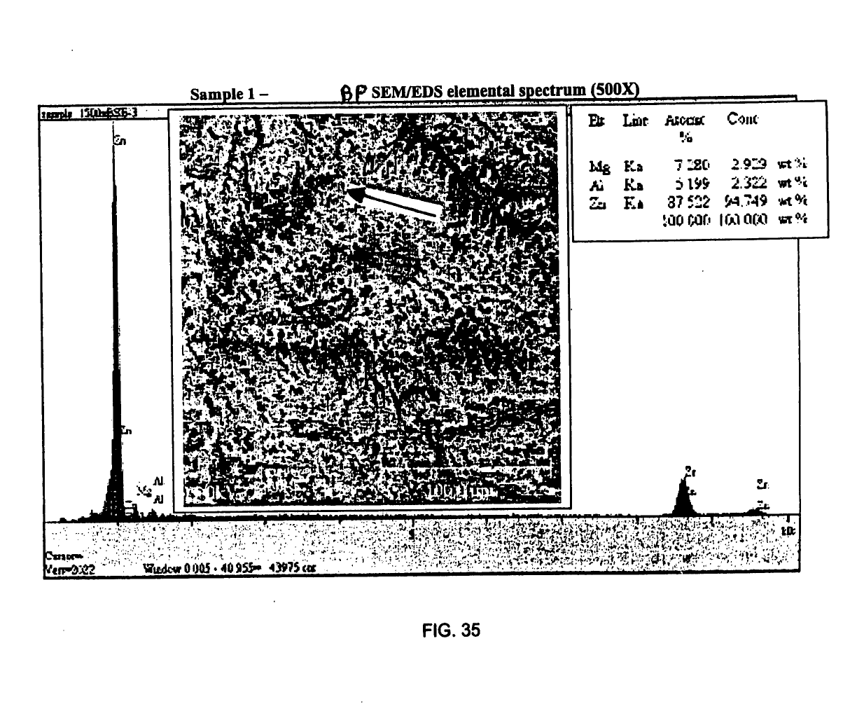

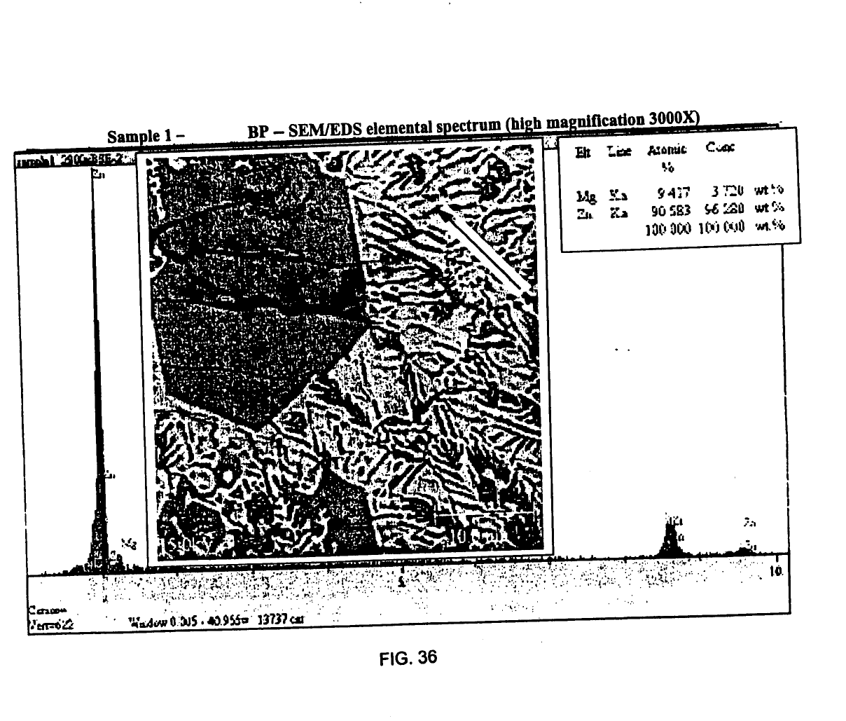

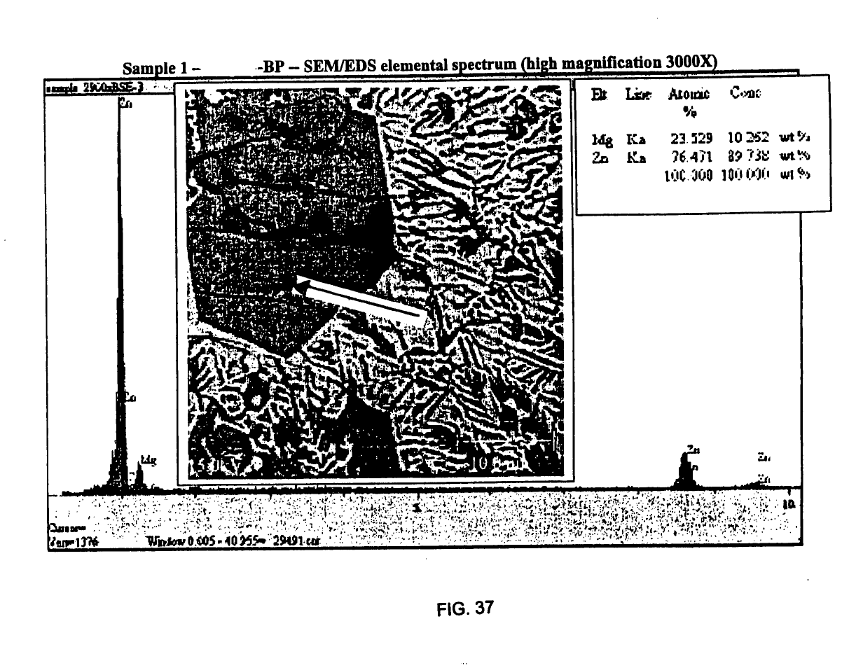

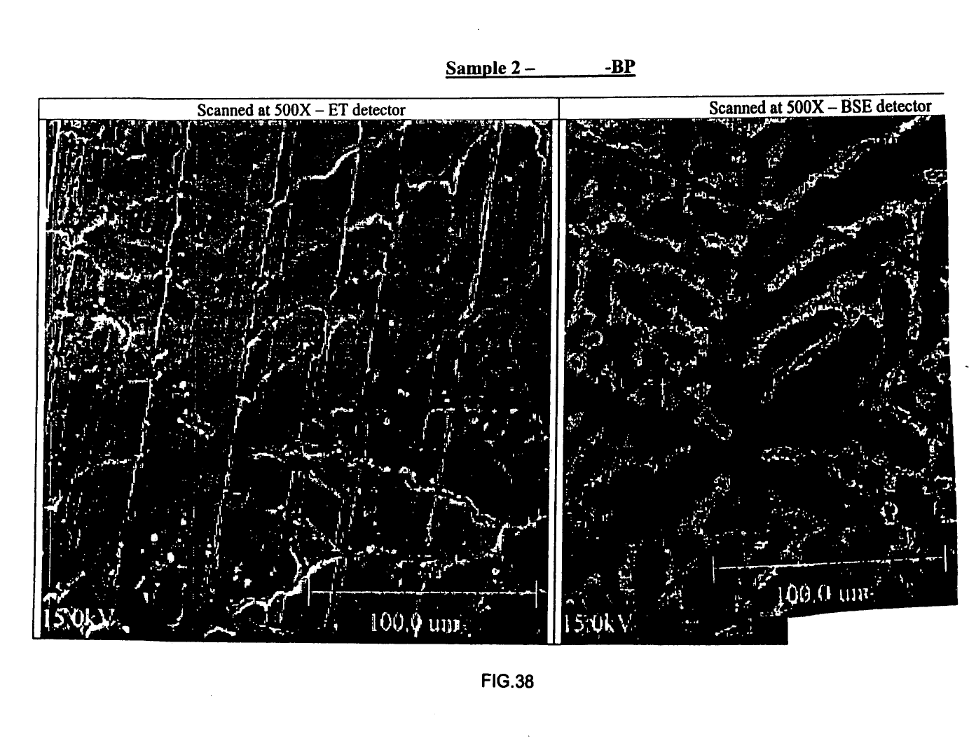

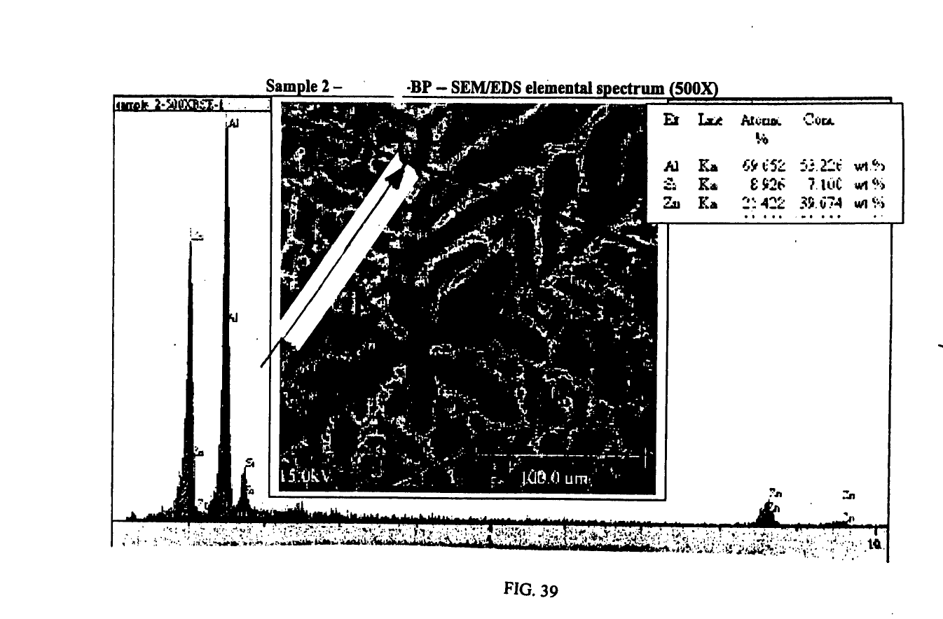

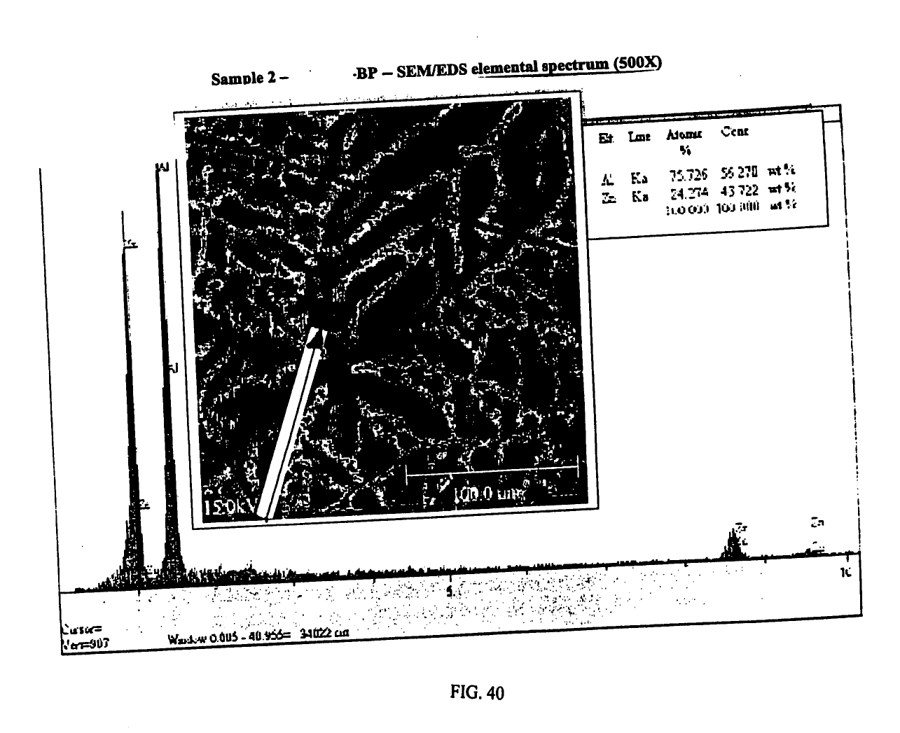

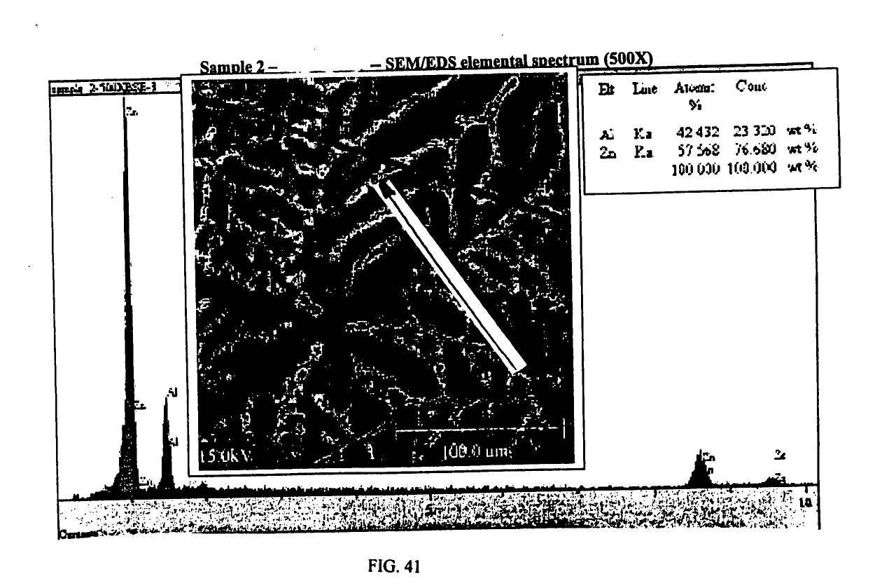

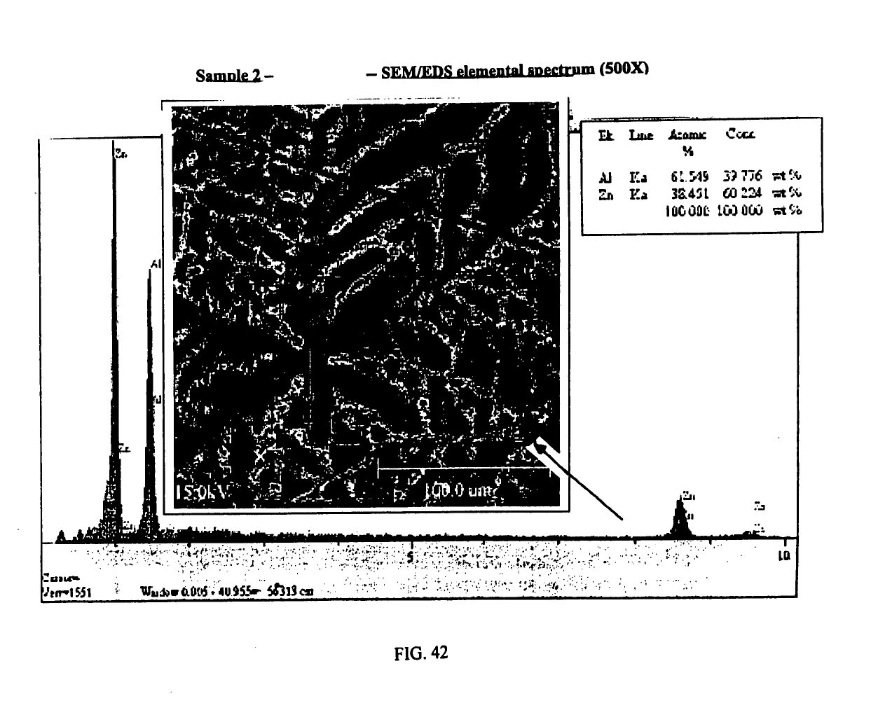

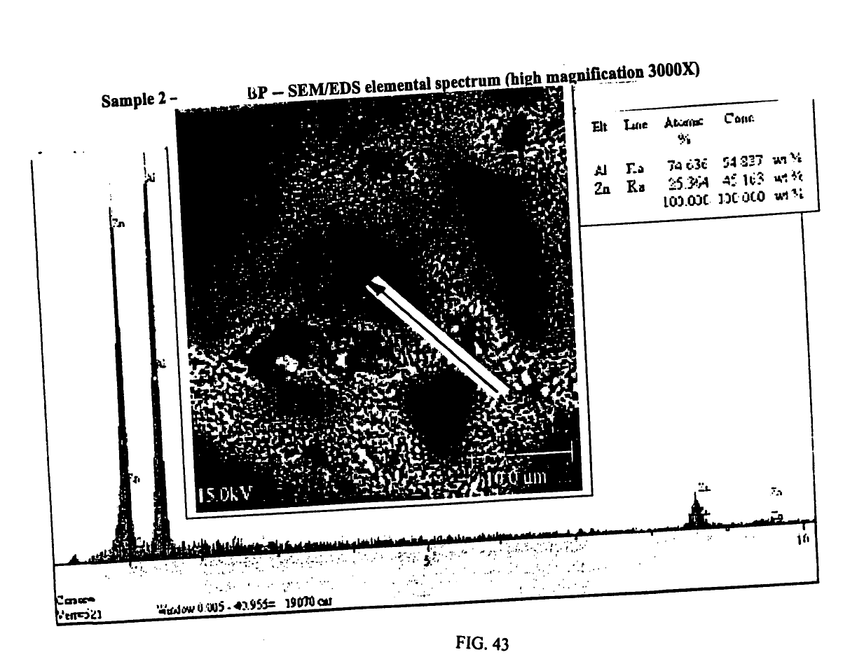

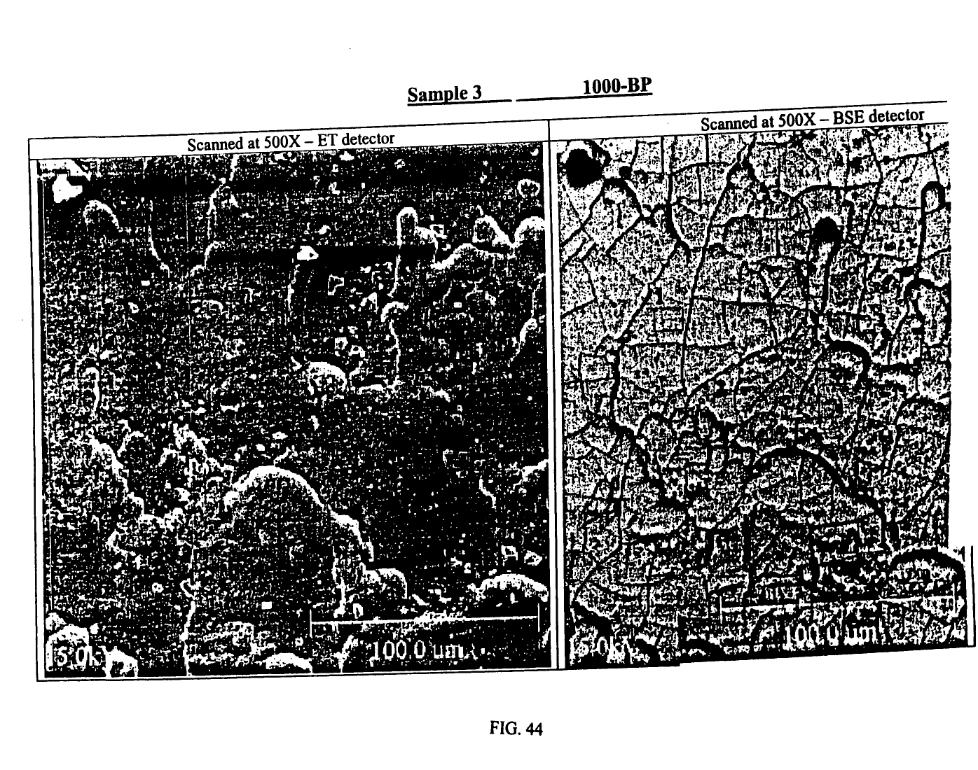

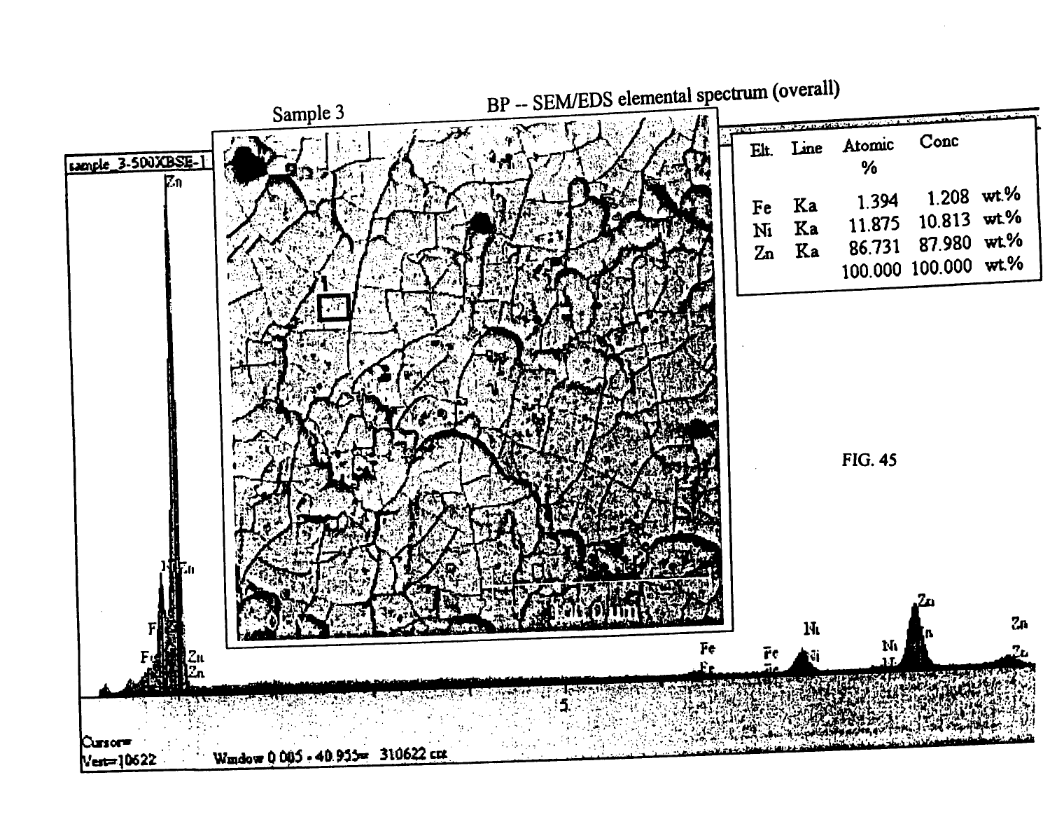

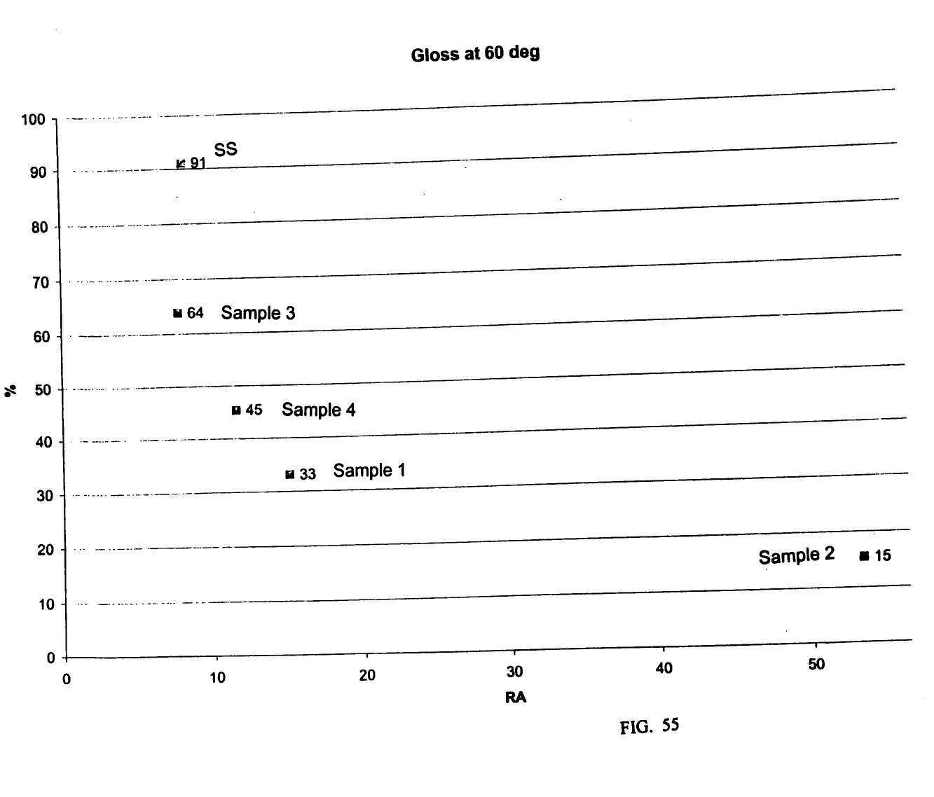

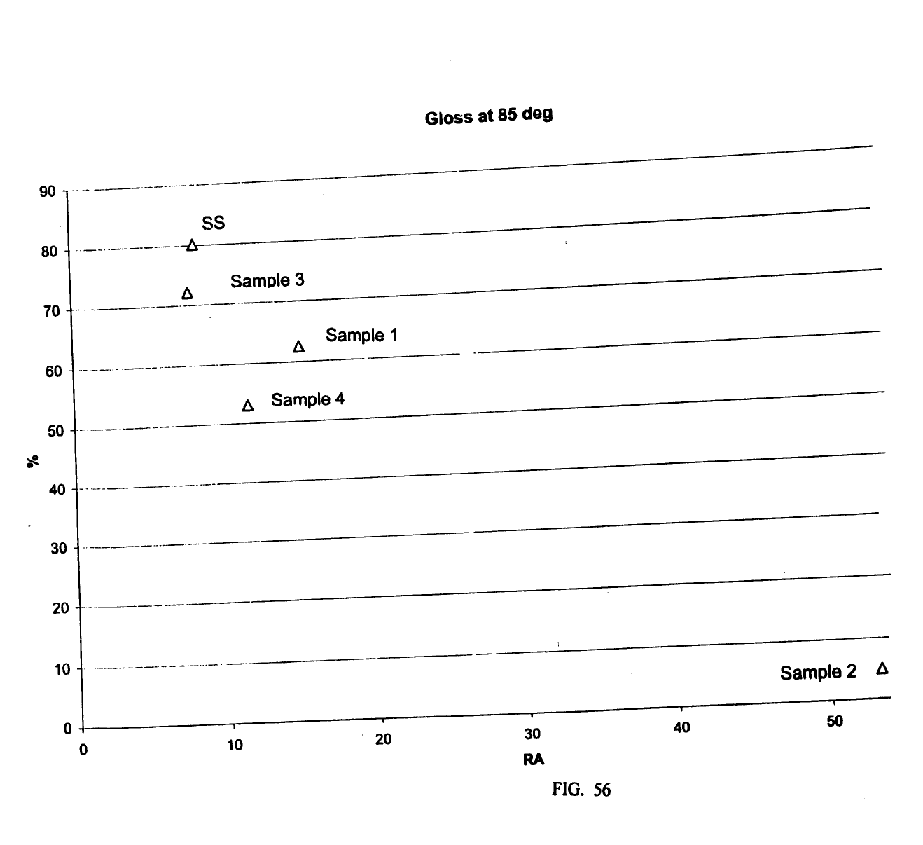

Samples 1-4 were produced according to the respective examples 1-4 and then tested and evaluated for the various parameters shown in FIGS. 6-58, which figures are self explanatory and several of which are explained further below.

Optical Properties

Method—Reflectivity

All spectra were acquired on a Perkin Elmer Lambda 950 ultraviolet-visible spectrophotometer equipped with a Lab Sphere model 60MM RSA ASSY integrating sphere. Spectra were acquired from 320 to 860 nm and auto corrected to a reference standard provided with the sphere by the manufacturer. Two sample mount configurations are available with the sphere. Spectra were acquired with the samples mounted normal to the incident radiation, which allows for collection of diffuse reflectance and with the samples mounted at a small angle off norm for collection of both diffuse and specular reflectance. Specular reflectance was determined by the difference between these spectra.

Results

The total and specular reflectivity was obtained for the reference polished stainless steel sample and for the coated samples 1-4 before and after polishing. Results are presented in the various figures discussed below.

FIG. 6 is a graph of the total and specular reflectance for the polished #4 finish stainless steel (SS) sample and is compared to the metal coatings on the samples 1-4 with the SS sample used as a reference.

The Sample 3 and 4 Coatings

The same coating process was applied to the samples 3 and 4 and thus it is believed that they should be similar in composition and structure.

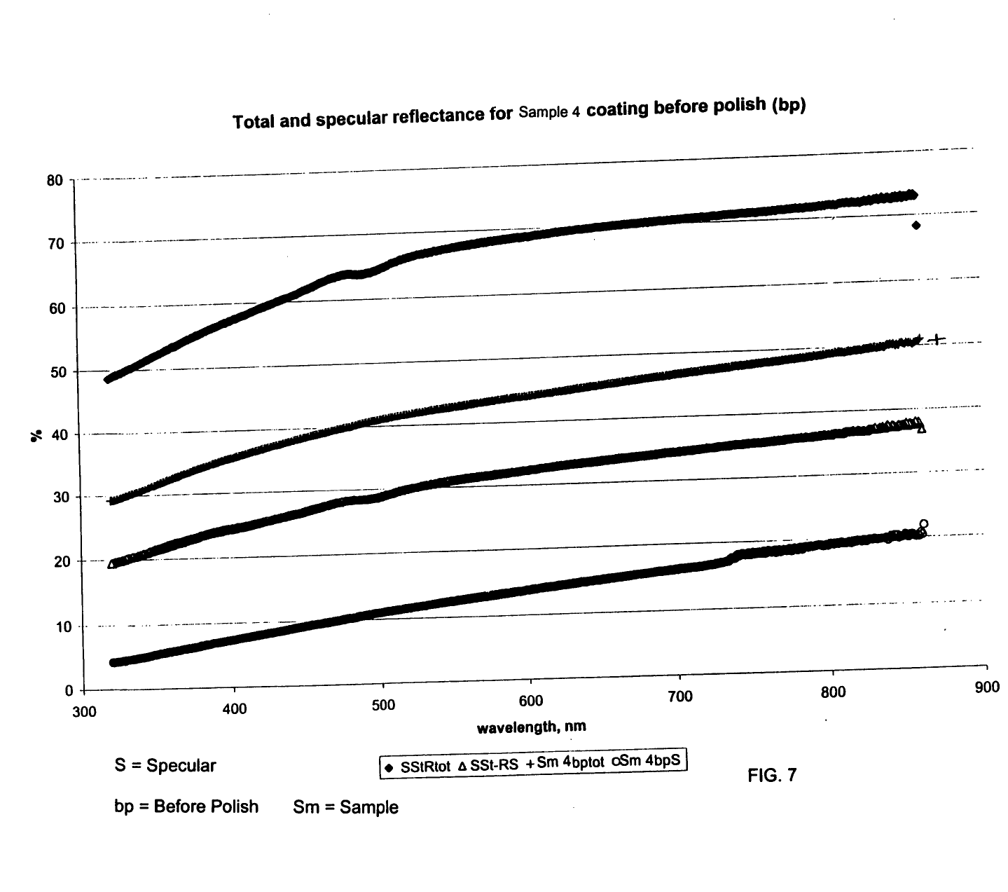

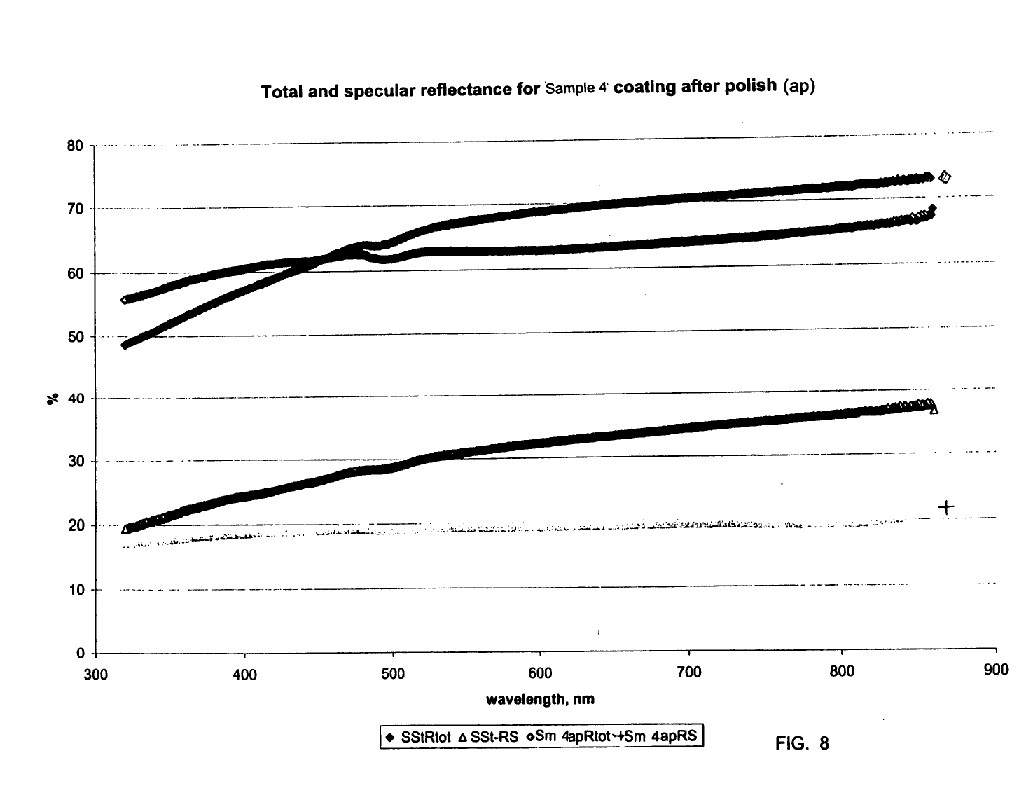

The sample 4 reflectance, before polish, is shown in FIG. 7. Both total and specular reflectances are lower compared with that of the polished stainless steel, about 30% less. After polish, FIG. 8, the total reflectance of the sample 4 coating increases and is identical to the total reflectance of stainless sample. The specular reflectance is lower for both the SS and sample 4 and it is practically flat, i.e. evenly low reflection in the entire spectrum for sample 4.

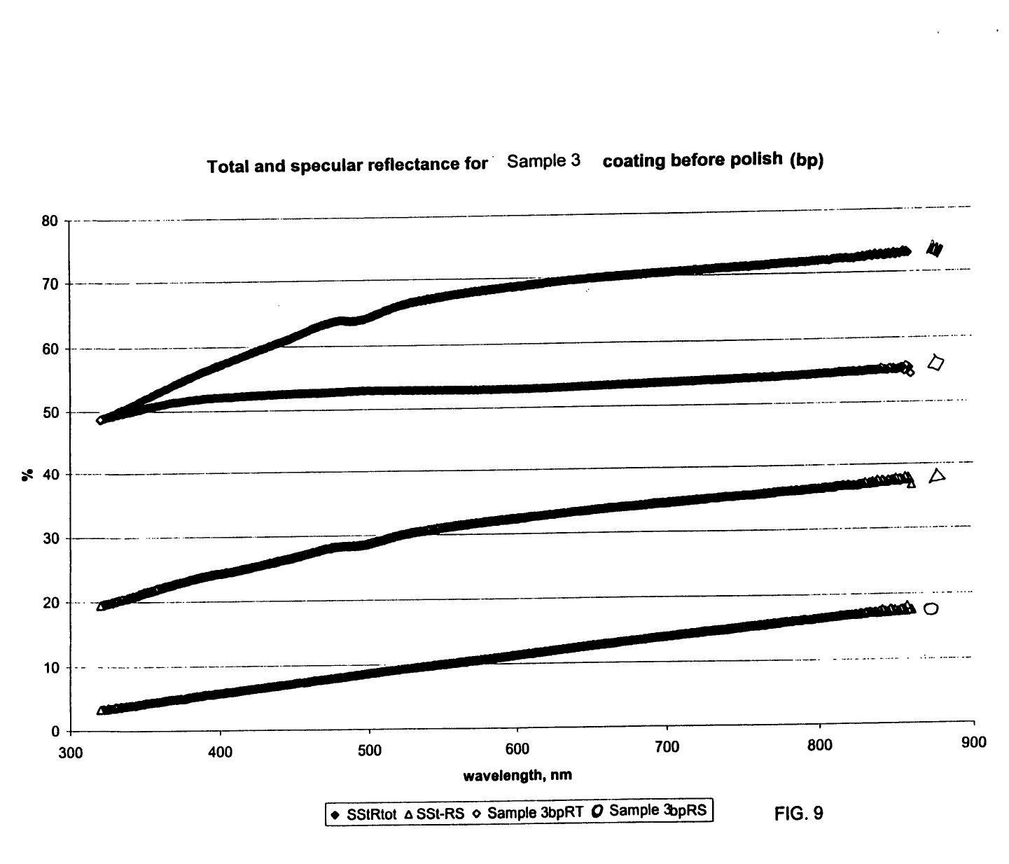

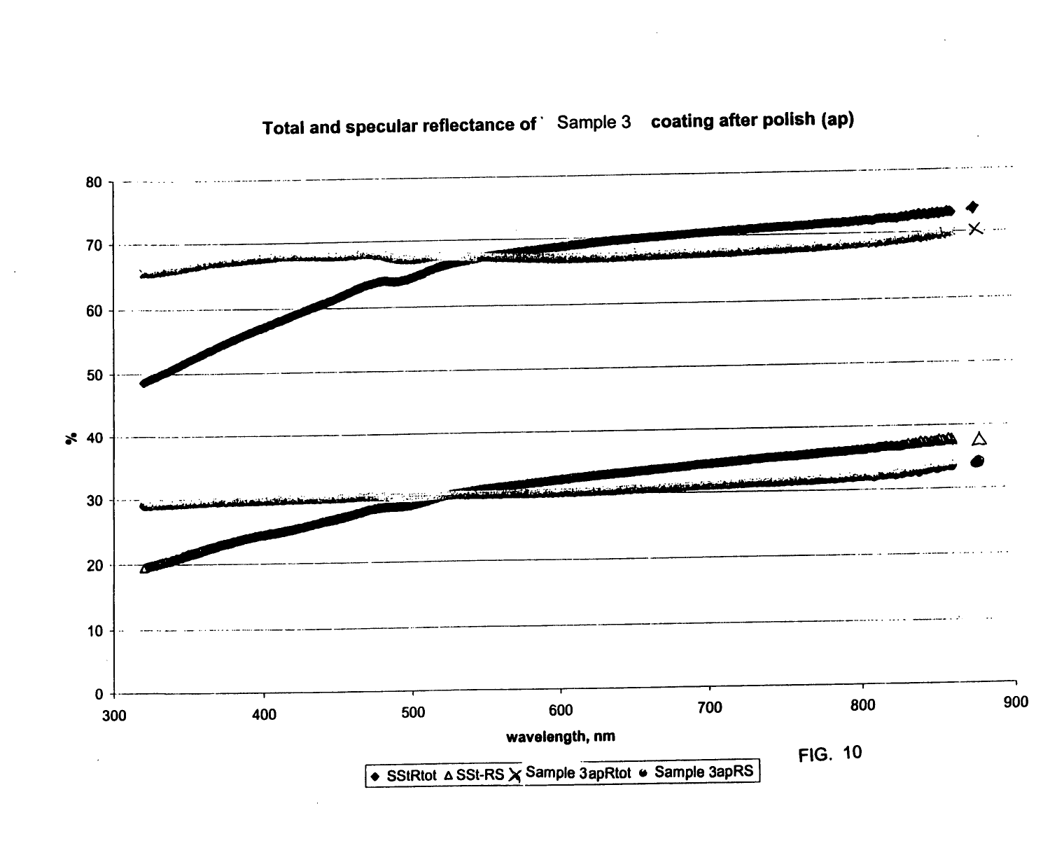

The sample 3 reflectance before polish is shown in FIG. 9. Both total and specular reflectances are lower compared with the polished stainless steel sample. After polish, FIG. 10, the total reflectance of the sample 3coating increases from about 30% to about 70% and is substantially identical to the total reflectance of stainless reference sample which reflectance is slightly insignificantly higher. The specular reflectance of the sample is similar in value to the stainless, but it is practically flat, which may be an indication of being closer to white. The bluish observation made in the examples discussed above may be attributed to the fact that the sample has an increased reflectance in the blue, i.e. shorter, wavelength part of the spectrum.

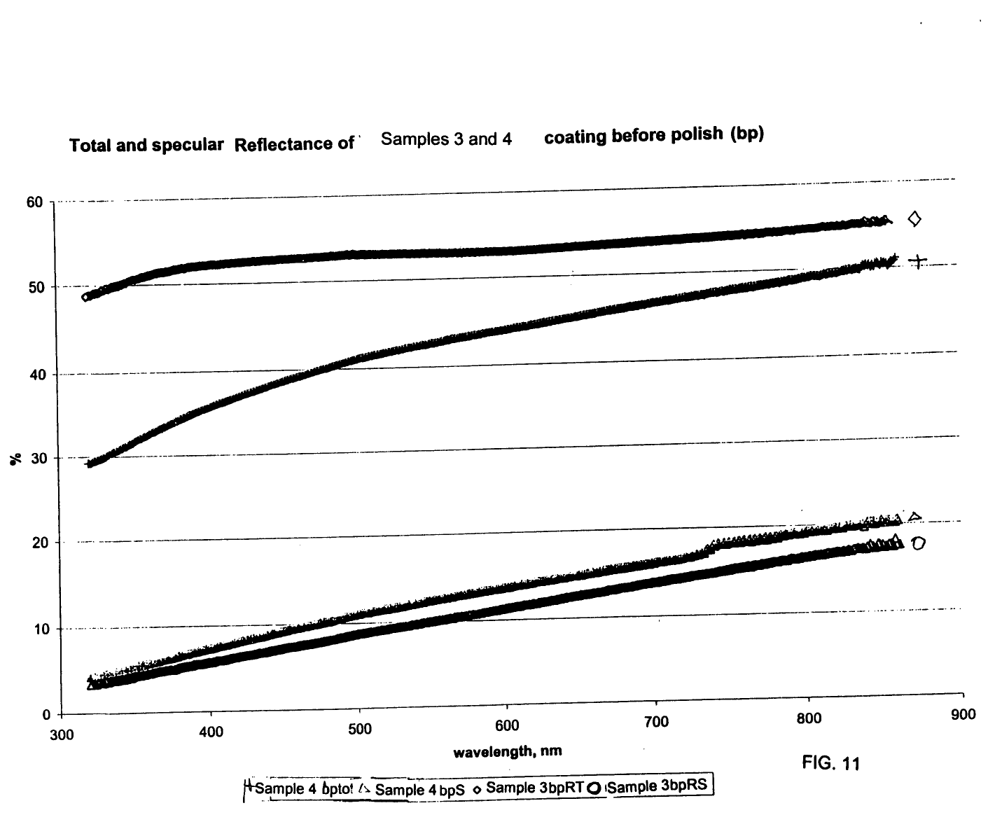

Comparison of the samples 3 and 4 coatings before polishing (bp) is shown in FIG. 11. The difference in total reflectance indicates a difference in surface condition, at least for the samples. This will be shown in the surface condition investigation below. The spectral reflectance for both samples is substantially identical with only a slight insignificant difference therebetween.

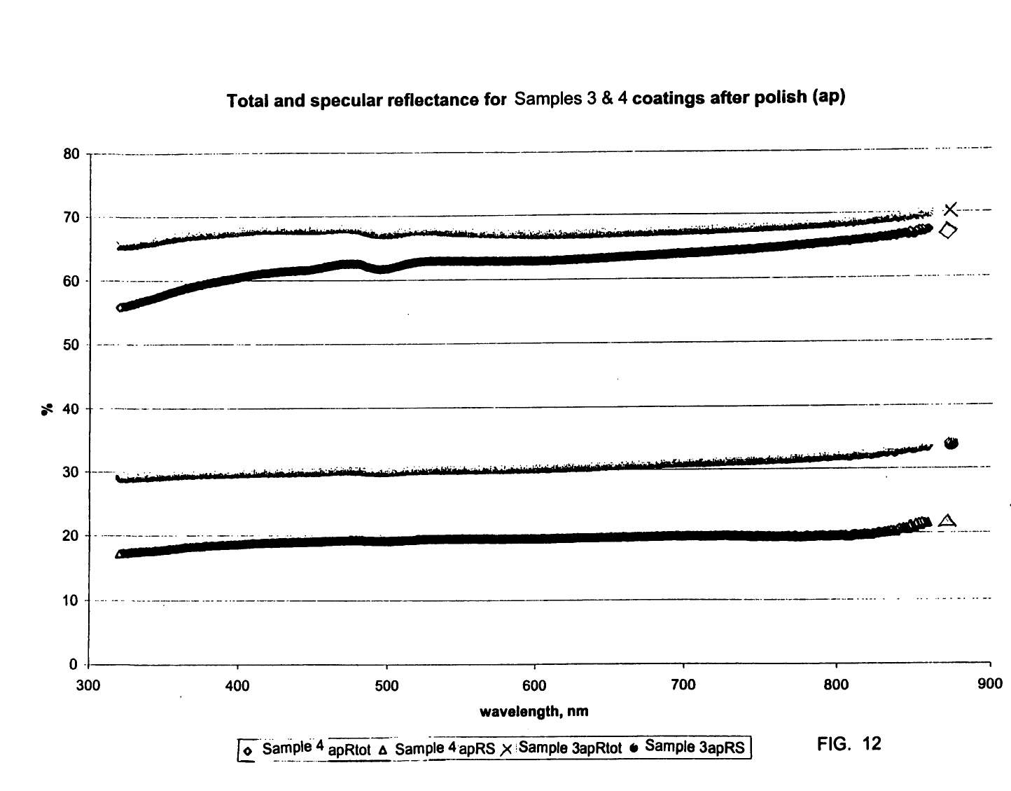

After polishing (ap), FIG. 12, both coatings have a substantially identical total reflectance with an insignificant slight difference, but the specular reflectance is lower by about 10% for the sample 4 coating.

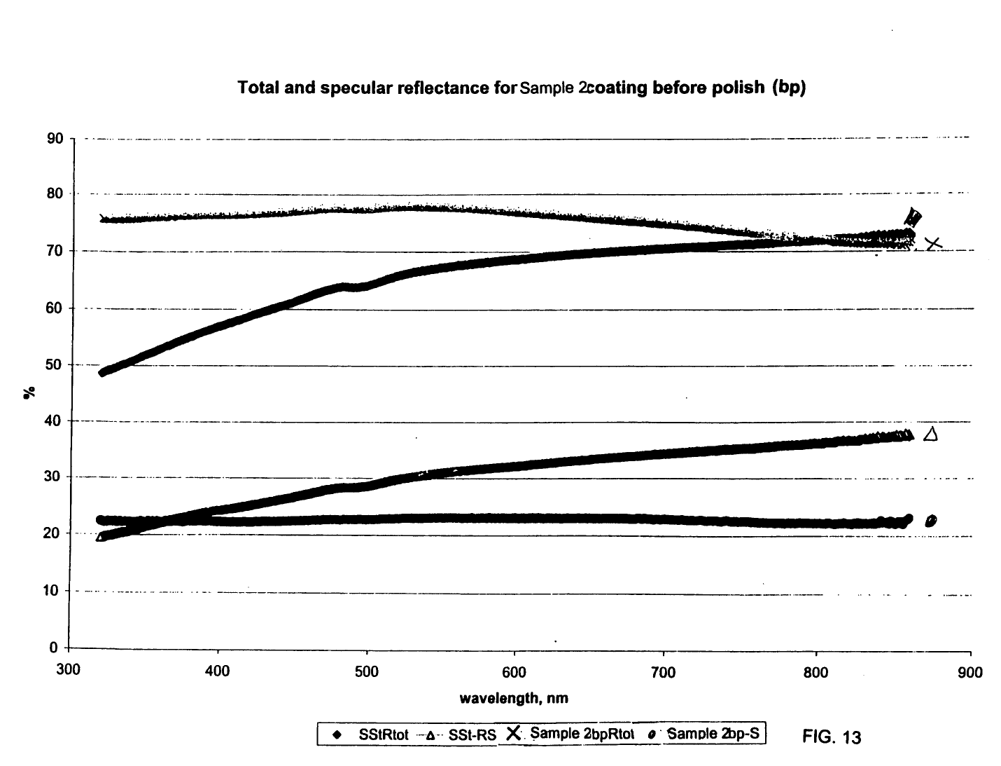

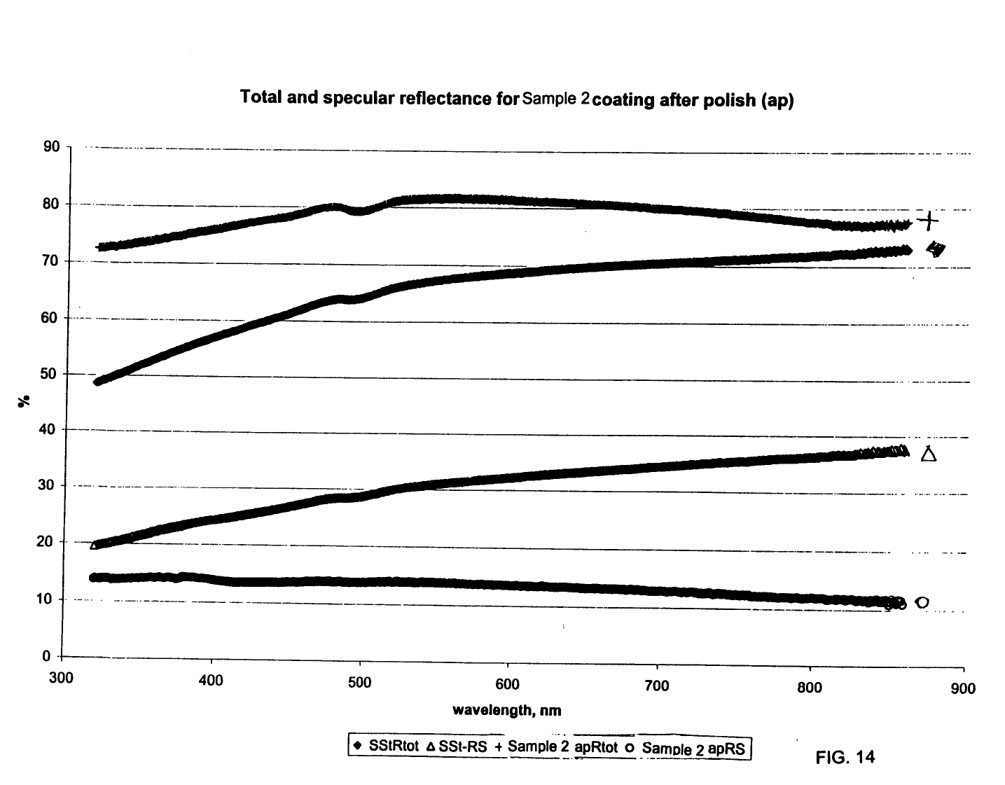

The sample 2 coating reflectance before polish is shown in FIG. 13. Total reflectance is higher and specular reflectance is lower compared with polished stainless reference sample. After polish, FIG. 14, the total reflectance of the sample 2 coating increases and is higher compared to the total reflectance of stainless reference sample. The specular reflectance of sample 2 is substantially lower and it is practically flat, i.e. evenly low reflection in the entire spectrum.

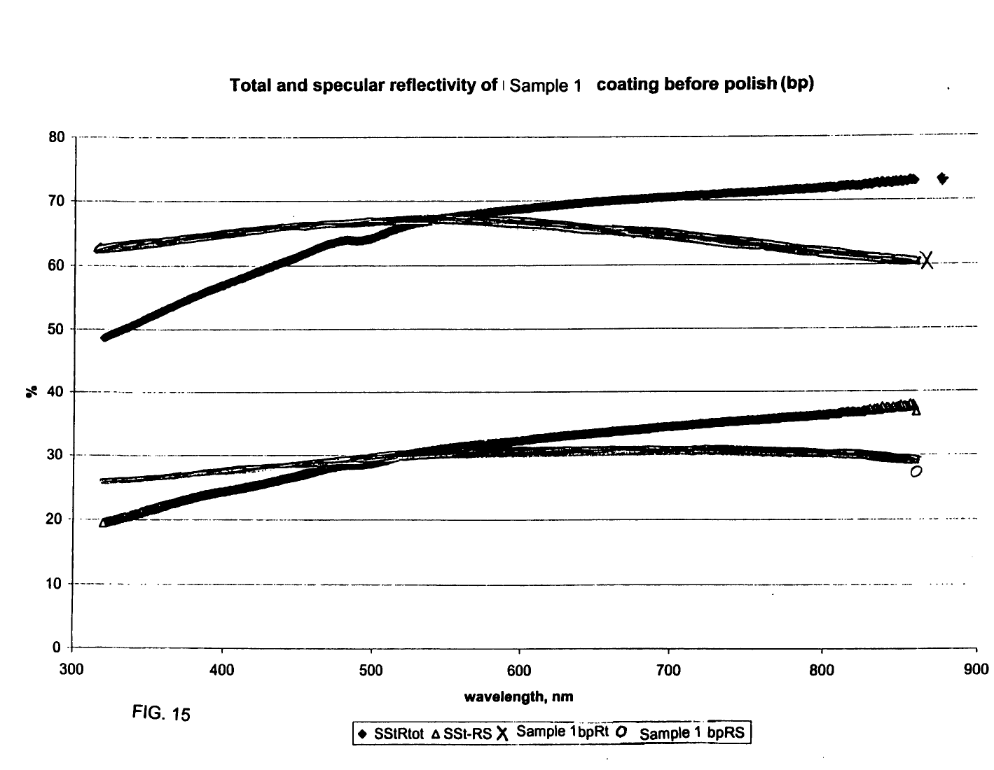

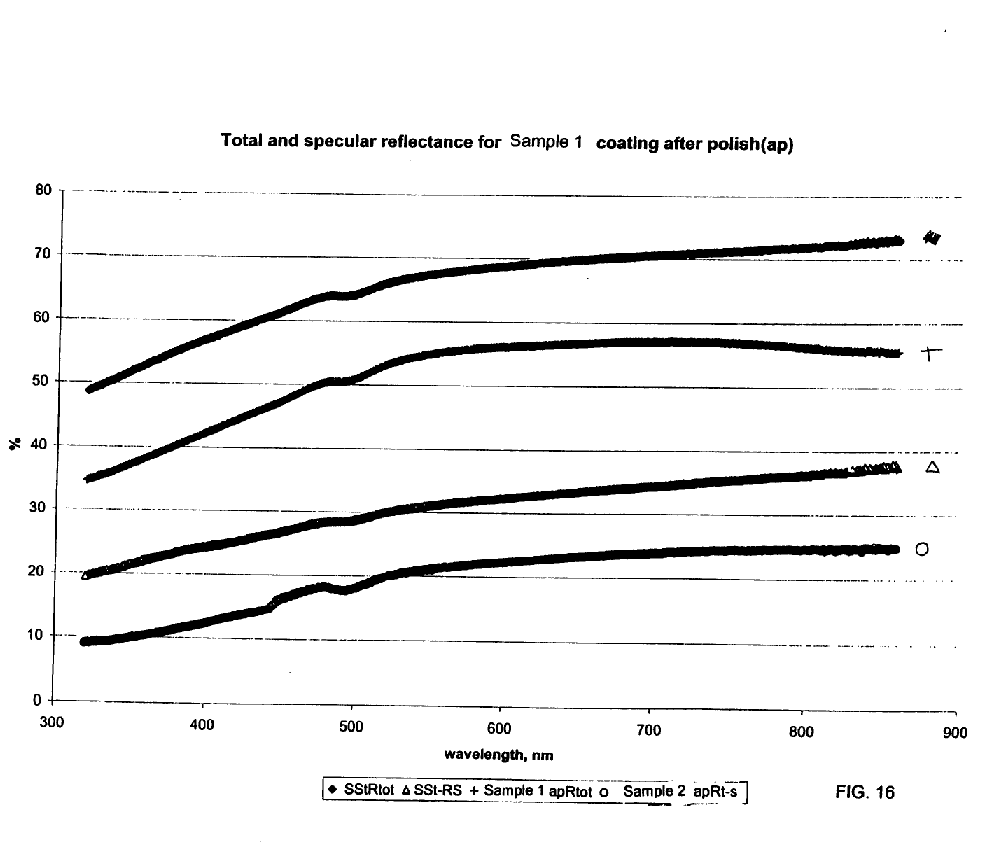

The sample 1 coating reflectance before polish is shown in FIG. 15. Total reflectance is higher in the short wavelength range and lower toward the longer wavelength range. Same holds for specular component. The coating is intrinsically “whiter” compared to stainless. This is not surprising due to the fact that the coating contains aluminum. Aluminum has very good reflectance in the shorter wavelength range. After polish, FIG. 16, both the total and specular reflectance are lower compared to the total reflectance of stainless sample and follow the pattern of the reflectances for stainless sample, but about 10-15% less.

Color and Gloss

Color Characteristics, L (lightness), a, b, CIE (white) and yellow (ASTM 313) were determined using an X-Rite SP68 Sphere Spectrophotometer with dual beam optics system. (a=Red-green axis, positive values are red hues, negative values are green hues, 0 is neutral; b=Yellow-blue axis, positive values are yellow hues, negative values are blue hues, 0 is neutral) The samples were placed under the target window of spectrophotometer and three readings were taken and averaged. The unit is calibrated before each use using a reflection standard.

Results—

The results of the color study on the four coated samples and stainless reference sample after polish are shown in Table 5. As can be observed therefrom, and as also shown later, there is correlation between the Table 5 data and the spectral data. For example “whiteness”/“yellowness” is closest between the stainless reference sample and sample 1. The sample 1 spectral curves conform with the stainless curves. Reflectance values are lower similar to the lower lightness value. Total reflectivity for samples 2, 3 and 4 coating after polish as well as lightness are higher than the stainless sample. The “whiteness” of these coating is higher, i.e., they reflect more evenly in the entire wavelength range. The gloss is lower, because specular reflection values are much lower compared with the stainless sample.

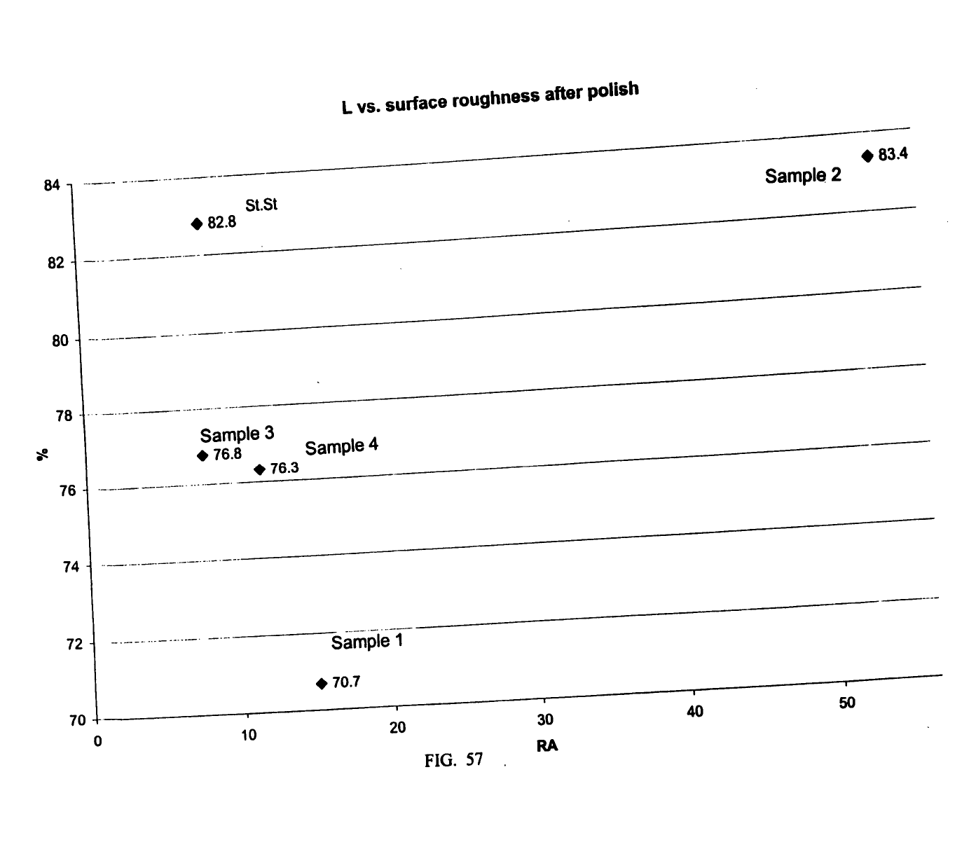

TABLE 5

| | Stainless | | | | |
|---|---|---|---|---|---|
| Color | Steel | Sample 1 | Sample 2 | Sample 3 | Sample 4 |
| L (See | 82.8 | 70.69 | 83.35 | 76.77 | 76.32 |
| FIG. 57) | | | | | |
| a | +0.15 | −0.20 | −0.22 | +0.17 | +0.22 |
| b | +4.63 | +3.48 | +0.66 | −2.18 | −1.86 |
| CIE | 38.18 | 21.48 | 59.50 | 62.97 | 60.52 |
| (white) | | | | | |
| ASTM | 7.92 | 6.73 | 0.95 | −4.47 | −3.85 |
| E313 | | | | | |
| (yellow) | | | | | |

Reflectance/Gloss

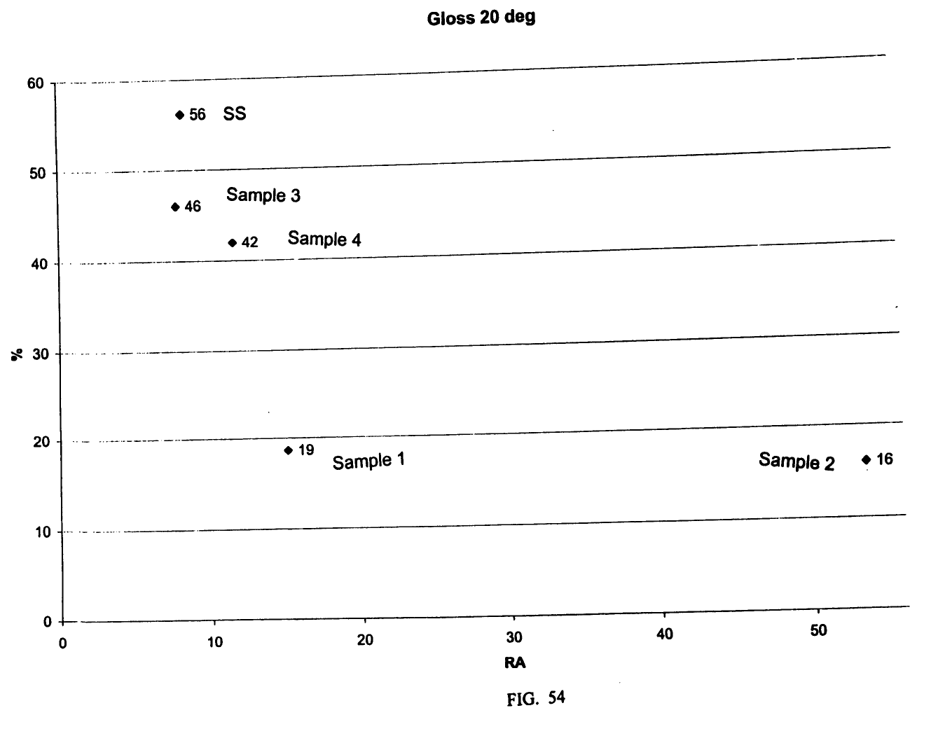

A Gardner Micro-Tri-Gloss Meter was employed to determine Reflectance/Gloss. The measurements were conducted at three different angles and the average of three tests was determined (See FIGS. 54-56). Light is directed onto the surface of the test specimen at a defined angle relative to the sample surface and the reflected light is measured photo-electrically. The unit is calibrated before each use using a calibration standard.

TABLE 6
(See FIGS. 54-56 where the angle is the angle relative to the
surface being viewed)
(% relate to the maximum amount)

| | Stainless | | | | |
|---|---|---|---|---|---|
| | Steel | Sample | | | |
| Gloss | Sample % | 1% | Sample 2% | Sample 4% | Sample 3% |
| 20° | 56.1 | 18.6 | 16.3 | 42.3 | 46.4 |
| 60° | 91.0 | 33.1 | 15.4 | 45.3 | 63.8 |
| 85° | 80.1 | 62.5 | 4.9 | 53.0 | 72.1 |

Surface Roughness

Federal Pocket III profilometer was used for this test. The average of four were determined.

TABLE 7

| Sample | Surface Roughness (RA) |
|---|---|
| Stainless Steel | 8.2 |
| 1 | 15 |
| 2 | 53.2 |
| 3 | 7.75 |
| 4 | 11.5 |

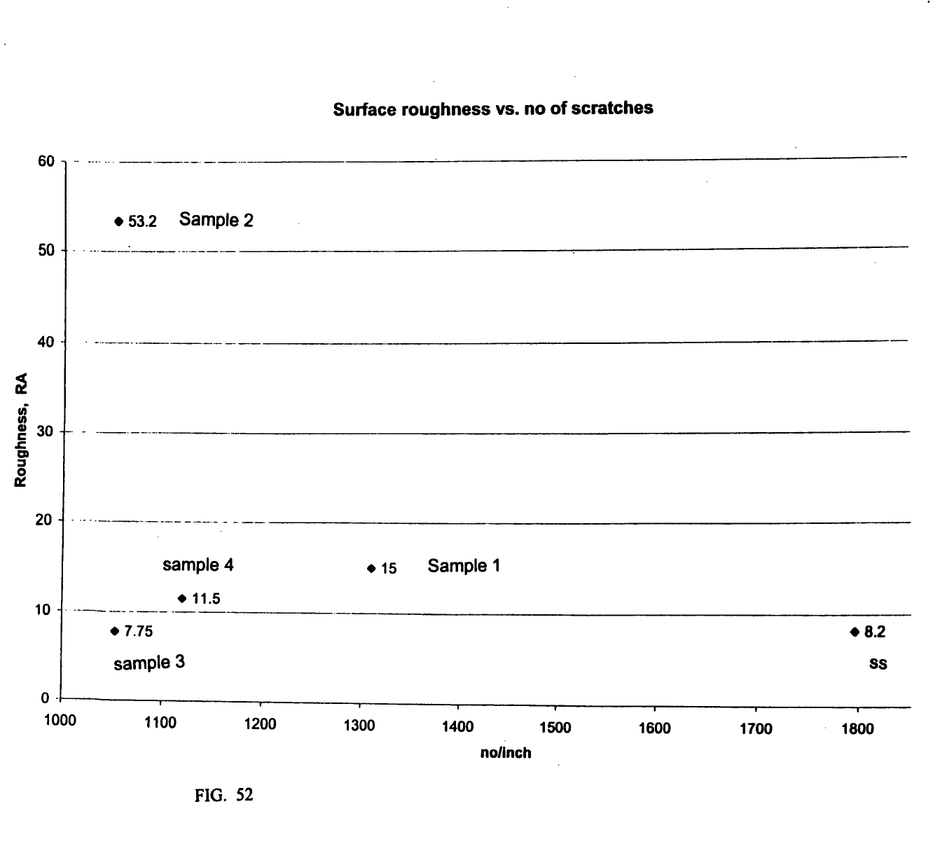

Note in FIG. 52, surface roughness vs. no. of scratches, that the SS sample had a significant number of more scratches per inch than the samples 1-4, 1800 vs. the range of about 1050 to 1300 scratches per inch for the samples and except for sample 2, the surface roughness of the samples is comparable to that of the SS. Therefor, the number of scratches per inch is not directly correlated to the simulation of SS by the samples.
Coating Thickness

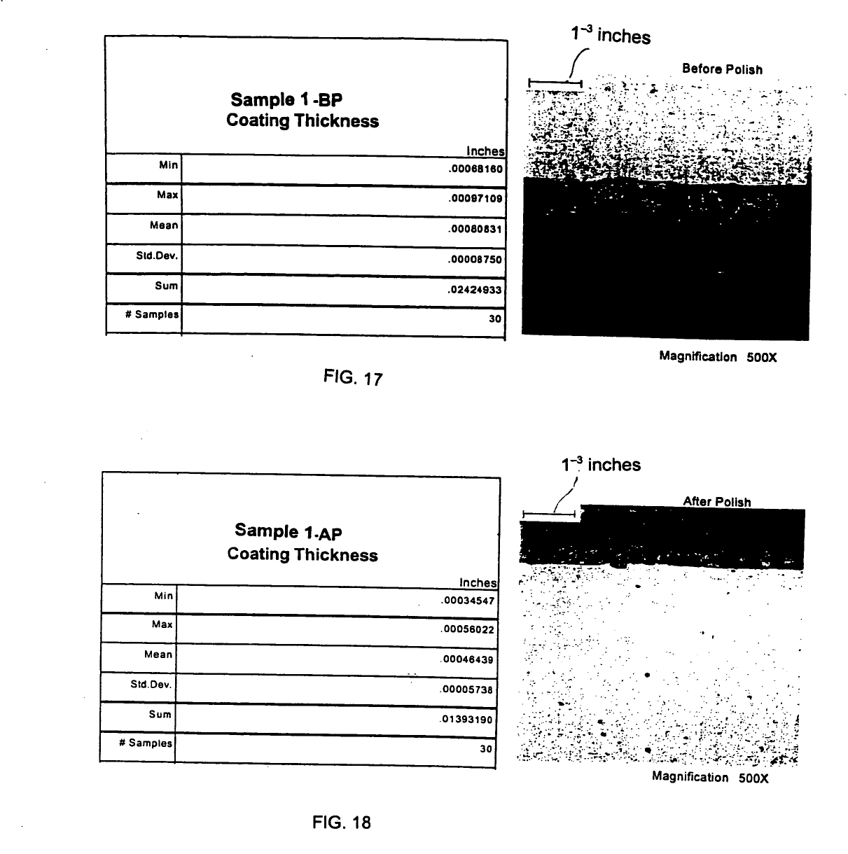

The coating thickness was determined by measuring coating cross-section using an optical microscope. The average of 30 measurements was calculated. Microphotographs of these cross sections are shown in FIGS. 17 through 24.

Coating Thickness, Inches

TABLE 8

| | sample = | | | | | | | |
|---|---|---|---|---|---|---|---|---|
| | 1-BP | 1-AP | 2-BP | 2-AP | 3-BP | 3-AP | 4-BP | 4-AP |
| Mean | 0.00081 | 0.00046 | 0.00074 | 0.000678 | 0.000319 | 0.000188 | 0.000275 | 0.00021 |
| Standard. Deviation | 0.000088 | 0.000057 | 0.000015 | 0.0000766 | 0.0000505 | .0000398 | 0.000037 | 0.000064 |

As is evident, the polishing operation removed approximately 50% of the coating.
Surface Characterization

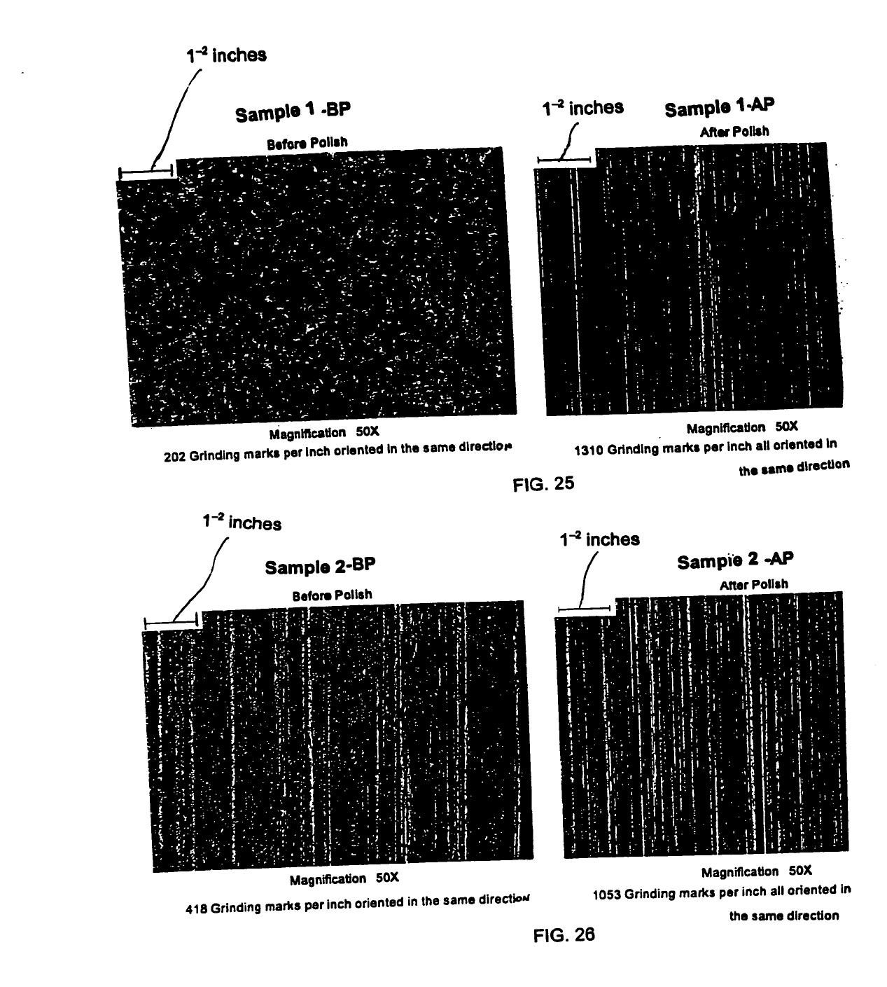

The surfaces of the samples were characterized using an optical scanning electron microscope. Grinding marks were counted using a stereoscope at magnification 50×. Optical images of the coating surface before (bp) and after polish (ap) are shown on microphotographs FIGS. 25 through 29. Samples 1, 2, 3 and 4 coatings have substantially different structure and morphology. The samples 1 and 2 coatings have relatively coarse dendritic structure. The coatings on samples 3 and 4 have fine-grained structure. Thus the coarseness or fineness of the microstructures are not directly correlated to the simulation of the SS sample finish.

Very fine lines were also observed under the optical microscope examination for samples 1, 3 and 4 coatings. Most probably this is a result of some sort of micro cracking. For the sample 2, the coating lines are clearly a result of grinding, intentional or not. All grinding marks are parallel to each other. The scratch density per inch and calculated scratch width are presented in Table 9 below.

TABLE 9
(Grinding marks per inch)

Sample

| | 1 | 2 | 3 | 4 | ST. STEEL |
|---|---|---|---|---|---|
| Lines per | 1310 | 1053 | 1053 | 1120 | 1796 |
| inch | | | | | |
| Width, μm | 19 | 24 | 24 | 23 | 14 |

Scanning Electron Microscope (SEM) Images and Coating Composition

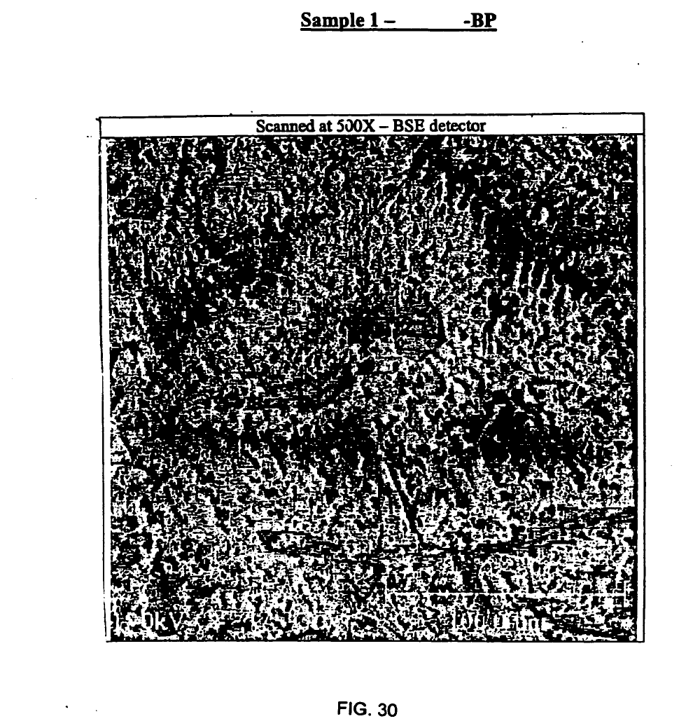

SEM images are presented in FIGS. 30 through 45. The coatings on the different samples have substantially different structure and morphology as also discussed above. The coatings on samples 1 and 2 have relatively coarse dendritic structure. The coatings on samples 3 and 4 have fine-grained structure.

The coating on sample 1 consists of about 25% aluminum and 75% Zn. Interdendritic areas are rich in zinc. The coating has two principal phases in its microstructure. One phase is the primary aluminum-rich dendritic phase that begins to grow initially during solidification. The other is an interdendritic zinc-rich region that forms when the zinc concentration in the solidifying liquid reaches a high level, because zinc has a lower melting point compared to aluminum and zinc rich composition and will solidify first. Some magnesium was also found between the grains. This is possibly a contamination from a rinsing process if water was used at any stage of treatment not known to the present inventors as the coating process was provided commercially by others.

The sample 2 coating 's interdendritic areas are rich in a lower melting point Zinc and aluminum with complete absence of Si in these areas. In intradendritic (inside the grain) areas composition is approximately 53% Al, 40% Zn and 7% Si. The coating has two principal phases in its microstructure. One phase is the primary aluminum-rich dendritic phase that begins to grow initially during solidification. The other phase is an interdendritic zinc-rich region that forms when the zinc concentration in the solidifying liquid reaches a high level, because zinc has a lower melting point compared to aluminum and the zinc rich composition solidifies first. The sample 2 has very clear grinding marks about 20 micron wide. The surface appears to have been abraded before final polish (the present inventors were not directly involved in the production of such coatings).

The samples 3 and 4 have a fine-grained, bumpy structure. They contain about 88% Zn, 10.8% Ni, and 1.25% Fe. This coating was produced by an electrogalvanizing process. This process yielded a more homogeneous chemical coating with some porosity.

The Differences Between the Coatings and the Effect the Differences May Have on the Final Product

The coatings on samples 1 and 2 appear to be produced by similar processes. These processes yield a coating with non-homogeneous chemistry on a micro scale. This non-homogeneity is considered to be advantageous in providing galvanic protection.

The coatings on samples 1 and 2 contain substantial amount of aluminum. That makes them intrinsically whiter compared to the coatings of samples 3 and 4 and of stainless steel. Nickel also has a whitening effect on Zinc, but not as much as aluminum.

The samples 3 and 4 coatings are substantially more chemically homogeneous compared to the samples 1 and 2 coatings. The absence of aluminum and presence of nickel is believed responsible for making them spectrally closer to stainless. Considering the possibility of tarnishing with time, the homogeneous coatings of samples 3 and 4 are believed to be more resistant to change in appearance with time.

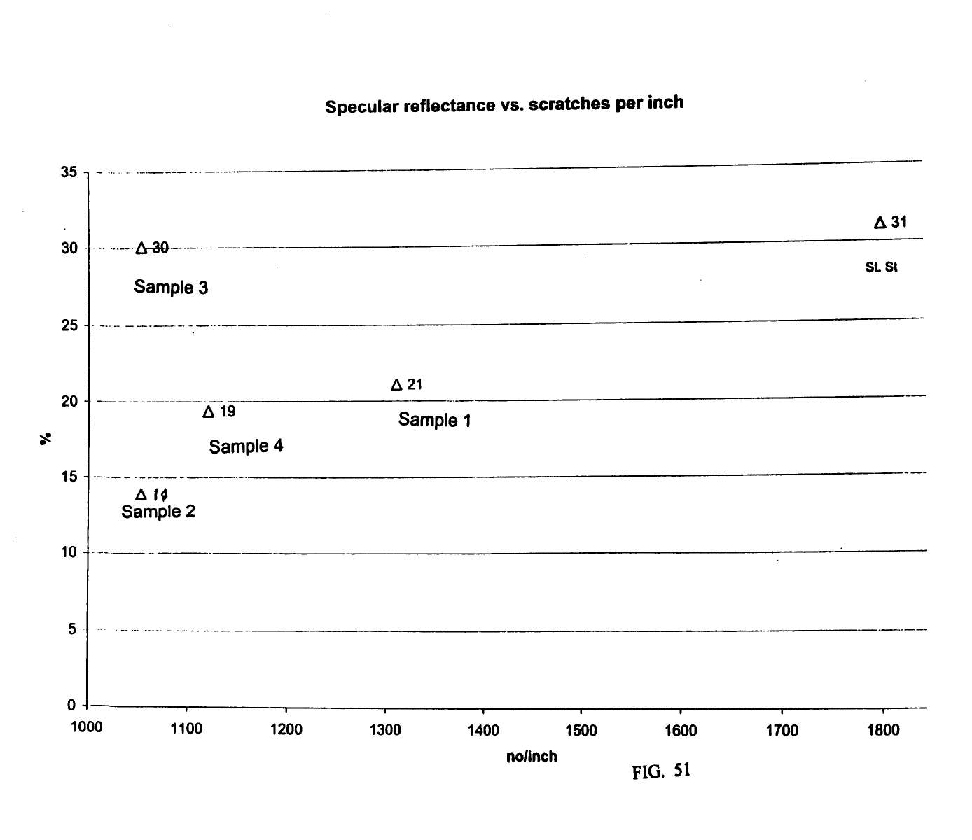

Reflectance and appearance depend, as shown below, on the intrinsic reflectance that is affected by composition and coating morphology as well as by the density of polishing marks. See Table 10 and FIG. 51. This is believed to be the reason for a lower specular reflectance of sample 4 coating with higher density of scratching marks per linear inch compared to the sample 3 coating with the same composition (See FIG. 51).

Chemical Composition of Substrates

Method

The composition of the substrate material of the samples was determined using an optical emission spectrometer.

TABLE 10
Sample 1 Composition - BP (before polishing)
Corresponds with Grade 1005

| Element | | Results % | Min % | Max % |
|---|---|---|---|---|
| C | = | 0.05 | 0.00 | 0.06 |
| Mn | = | 0.15 | 0.00 | 0.35 |
| P | = | 0.014 | 0.000 | 0.040 |
| S | = | 0.009 | 0.000 | 0.051 |
| Si | = | 0.01 | 0.00 | NS |
| Cr | = | 0.02 | 0.00 | NS |
| Ni | = | 0.02 | 0.00 | NS |
| Mo | < | 0.01 | 0.00 | NS |
| Cu | = | 0.01 | 0.00 | NS |
| Al | = | 0.03 | 0.00 | NS |
| Fe | = | Balance | Balance | Balance |

TABLE 11
Sample 2 Composition - BP (before polishing)
Corresponds with Grade 1010

| Element | | Results % | Min % | Max % |
|---|---|---|---|---|
| C | = | 0.08 | 0.08 | 0.13 |
| Mn | = | 0.34 | 0.30 | 0.60 |
| P | = | 0.007 | 0.000 | 0.030 |
| S | = | 0.007 | 0.000 | 0.050 |
| Si | = | 0.01 | 0.00 | NS |
| Cr | = | 0.04 | 0.00 | NS |
| Ni | = | 0.03 | 0.00 | NS |
| Mo | = | 0.01 | 0.00 | NS |
| Cu | = | 0.06 | 0.00 | NS |
| Al | = | 0.04 | 0.00 | NS |
| Fe | = | Balance | Balance | Balance |

TABLE 12
Sample 3 Composition - BP (before polishing)
Corresponds with Grade 1008

| Element | | Results % | Min % | Max % |
|---|---|---|---|---|
| C | = | 0.07 | 0.00 | 0.10 |
| Mn | = | 0.37 | 0.30 | 0.50 |
| P | = | 0.010 | 0.000 | 0.040 |
| S | = | 0.005 | 0.000 | 0.050 |
| Si | = | 0.04 | 0.00 | NS |
| Cr | = | 0.05 | 0.00 | NS |
| Ni | = | 0.04 | 0.00 | NS |
| Mo | < | 0.01 | 0.00 | NS |
| Cu | = | 0.12 | 0.00 | NS |
| Al | = | 0.03 | 0.00 | NS |
| Fe | = | Balance | Balance | Balance |

Chemical Analysis Performed by Optical Emission per SPO 2.02, Revision 1

TABLE 13
Sample 4 Composition - BP (before polishing)
Corresponds with Grade 1008

| Element | | Results % | Min % | Max % |
|---|---|---|---|---|
| C | = | 0.07 | 0.00 | 0.10 |
| Mn | = | 0.37 | 0.30 | 0.50 |
| P | = | 0.010 | 0.000 | 0.040 |
| S | = | 0.005 | 0.000 | 0.050 |
| Si | = | 0.04 | 0.00 | NS |
| Cr | = | 0.05 | 0.00 | NS |
| Ni | = | 0.04 | 0.00 | NS |
| Mo | < | 0.01 | 0.00 | NS |
| Cu | = | 0.12 | 0.00 | NS |
| Al | = | 0.03 | 0.00 | NS |
| Fe | = | Balance | Balance | Balance |

Micro Hardness
Method
Micro hardness was measure employing an LECO Microhardness Tester LM700.
A Knoop Indenter with 10gf-applied load was used. The average of at least 10 indentations was determined.
Results

Values in the Table 14 represent coating microhardness before polish for each of the four substrates. The coatings are very soft, which is typical for these coatings. Microhardness is around 40 KH. The higher value of the hardness for the sample 2 resulted from significant number of the grinding scratches already present before the polishing that caused work hardening of the coating.

TABLE 14

Sample (BP)

| | ST. ST | 1 | 2 | 3 | 4 |
|---|---|---|---|---|---|
| KH | 212.4 | 44.60 | 71.8 | 44.1 | 34.3 |
| St. Dev | 12.11 | 9.24 | 5.22 | 8.01 | 5.28 |

Comparison Between Stainless Steel and the Four Sample Coatings

Correlation

Correlation between reflectance and coating characteristics.

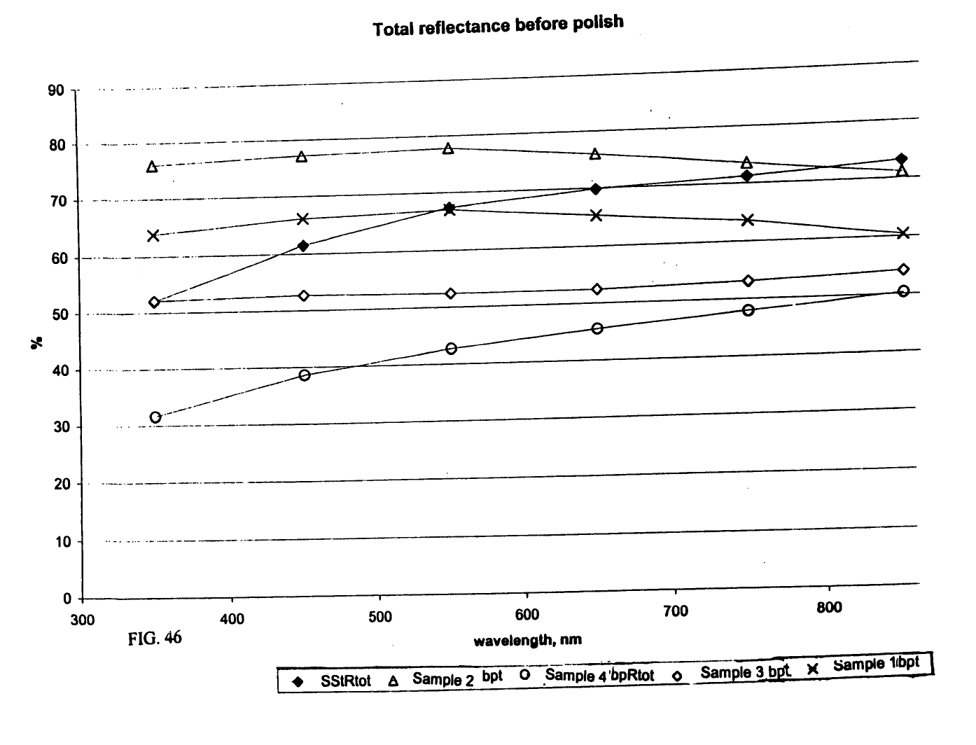

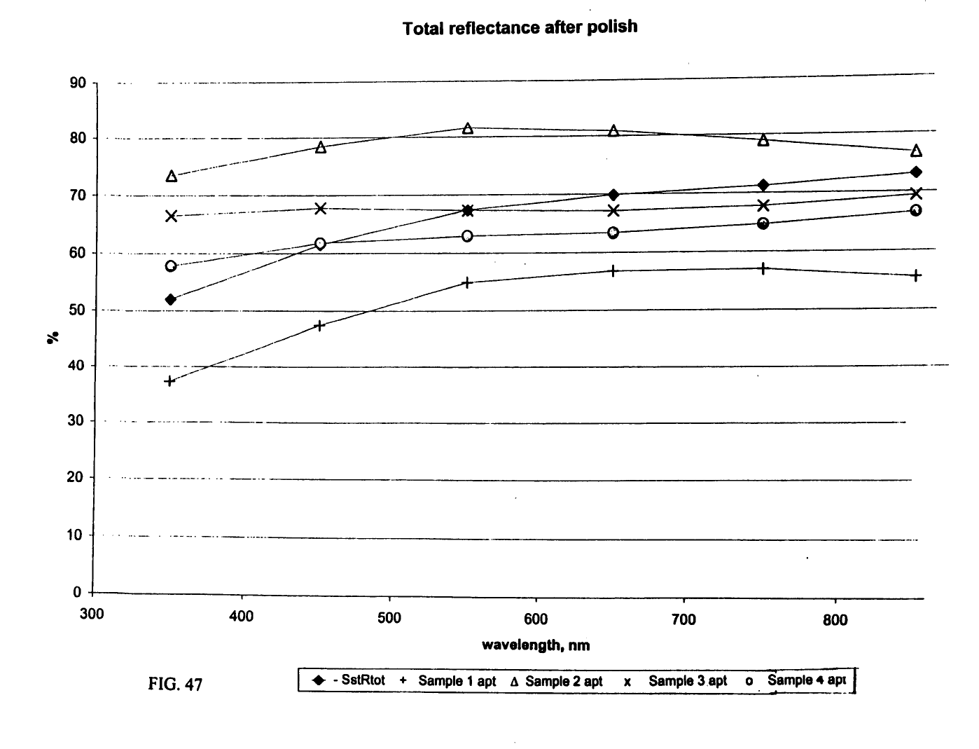

FIG. 46 compares total reflectance before polish (bpt) for the coatings on the four samples and on the polished stainless steel. FIG. 47 compares the total reflection of the coatings after polish (apt) for the four samples.

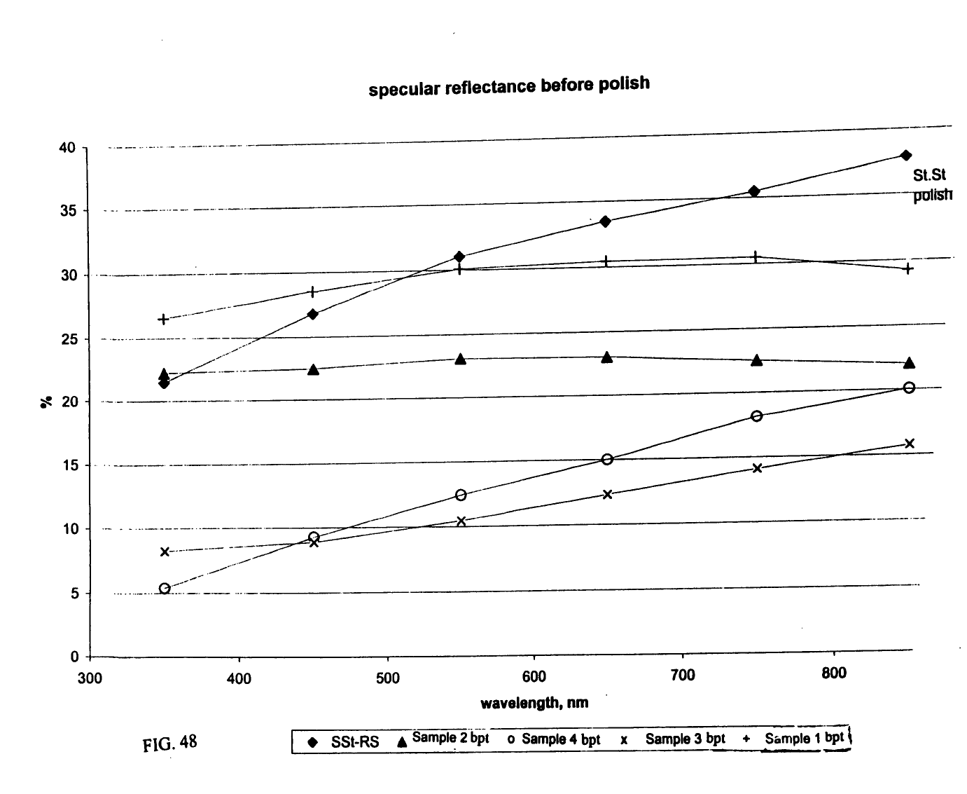

FIG. 48 compares the specular reflection of the four coatings and the polished stainless before polish (bpt).

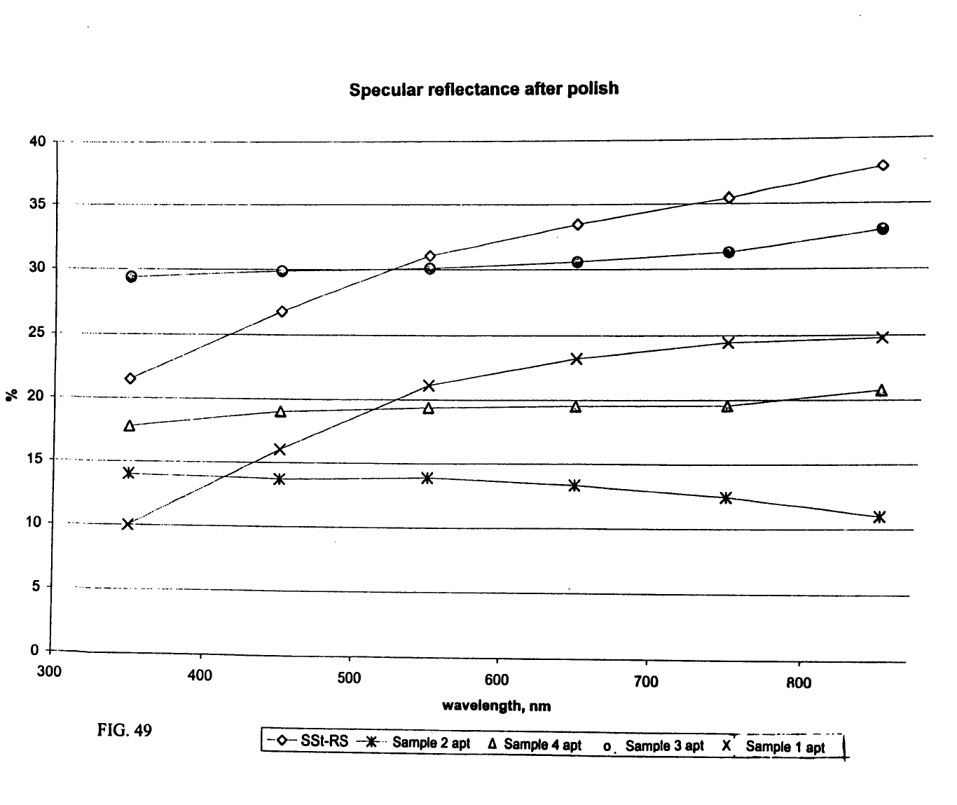

FIG. 49 compares the specular reflection of the four coatings and polished stainless after polish (aps). Except for the specular reflectance, 9 gloss, of the sample 3, the specular reflectance of the coatings is lower compared to polished stainless. All but sample 1 have a “whiter”, i.e. flatter reflectance.

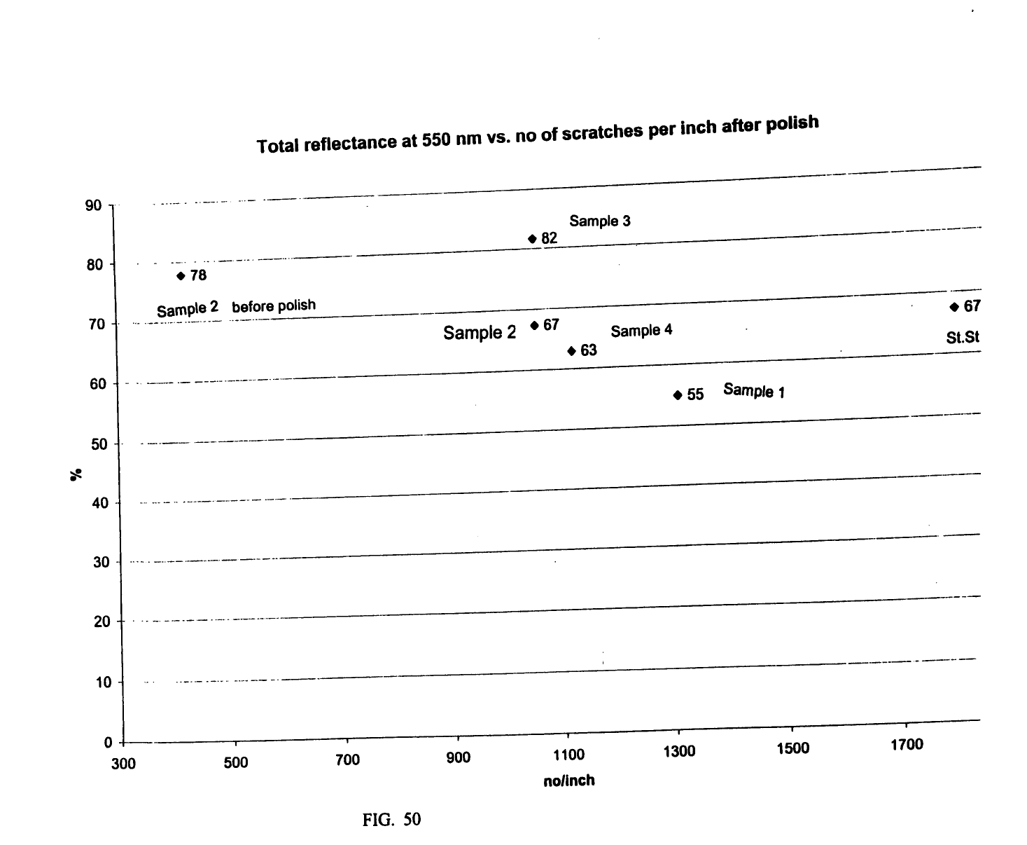

FIG. 50 shows the correlation between number of scratches and total reflectance at 550 nm after polish. It appears that for the coatings, the total reflection decreases with the number of scratches.

In FIG. 51, to some degree, the total reflection also decreases with the number of scratches with respect to the specular reflection. The Intrinsic composition is believed to play a role.

FIG. 52 shows some correlation exists between the number of scratches and the surface roughness.

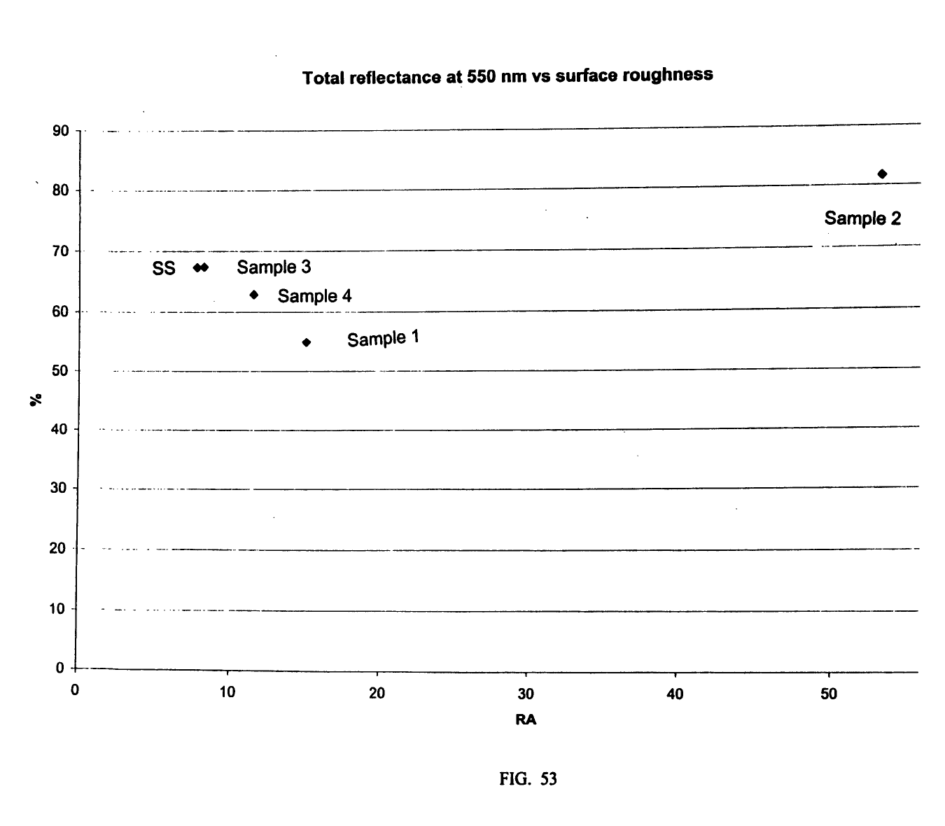

FIG. 53 appears to provide correlation between the surface roughness and total reflectance. The exception is the sample 2 coating with relatively high aluminum content.

FIGS. 54, 55 and 56 show that gloss at respective 20 degrees, 60 degrees and 85 degrees correlate with surface roughness

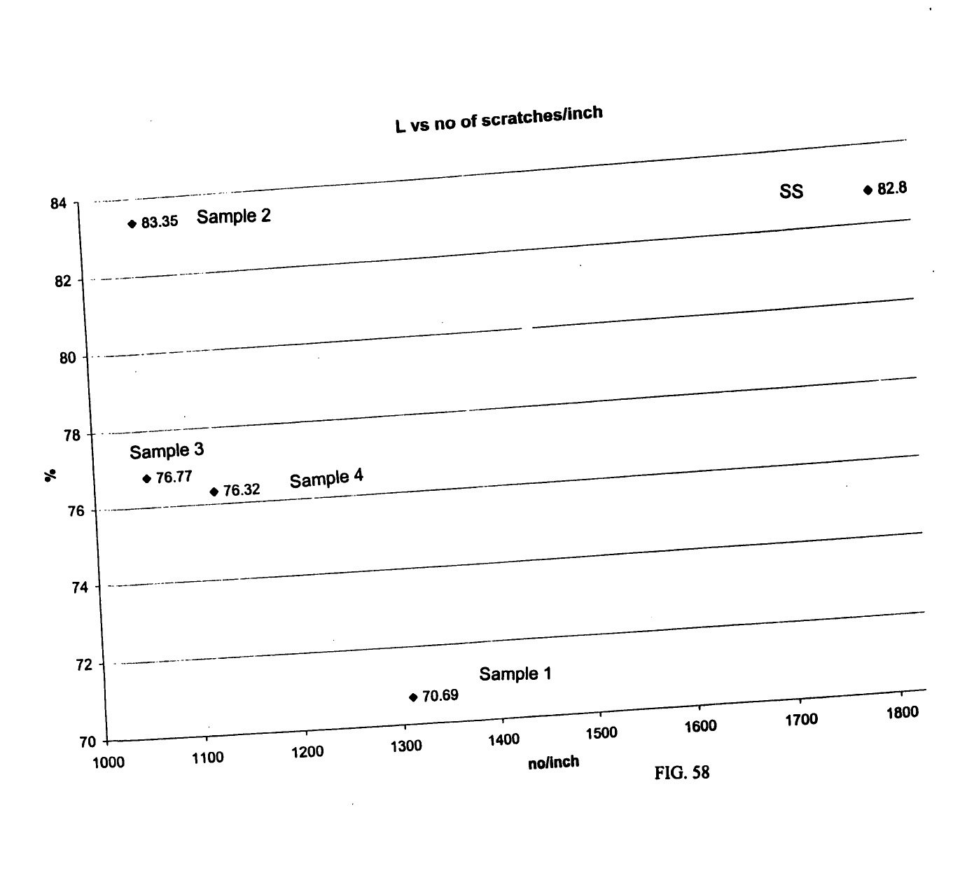

FIG. 57 shows lightness L versus surface roughness after polish and FIG. 58 shows lightness L versus number of scratches per inch after polish.

FIG. 58 shows lightness L versus number of scratches per inch after polish.

It will occur that modifications may be made to the disclosed embodiments by one of ordinary skill. The disclosed embodiments are given by way of example and not limitation. For example, the exemplary descriptions herein are of the processes to reproduce a #4 finish using various alloy composition coatings on a carbon steel sheet core. By way of further example, the metal coating may be applied to a non-metal substrate such as plastic, or other relatively stiff sheet material. For example, a sheet metal foil or other metallic sheet material may be bonded to a non-metal substrate. The metal alloy coating for receiving the faux SS finish is deposited onto the sheet metal foil or other metallic sheet material. The SS finish may then be applied to the so deposited metal alloy coating.

In addition, abrading processes, not shown or described specifically herein, but utilizing the apparatus disclosed herein or similar apparatus, may be used to provide standard or non-standard faux SS finishes. Such processes may be developed empirically by one of ordinary skill without undue experimentation. It is intended that the scope of the invention be defined by the following claims appended hereto.

1. A faux polished stainless steel sheet comprising:
a sheet material;
a metal coating on a surface of the sheet material; and
an abrasive grit polished finish on the exterior surface of the metal coating, which finish simulates polished stainless steel.

2. The faux stainless steel sheet of claim 1 wherein the metal coating is an alloy.

3. The faux stainless steel sheet of claim 1 wherein the sheet material is a non-stainless steel metal.

4. The faux stainless steel sheet of claim 1 wherein the sheet material is carbon steel.

5. The faux stainless steel sheet of claim 1 wherein the coating comprises an alloy of zinc.

6. The faux stainless steel sheet of claim 1 wherein the coating comprises an alloy of zinc having a composition in the range of about 40% to about 90% by weight zinc and one of aluminum and nickel in the range of 20 to 58% by weight aluminum and 10-30% by weight nickel.

7. The faux stainless steel sheet of claim 1 wherein the coating comprises an alloy selected from the group consisting of 1) about 80% zinc and about 20% aluminum by weight, 2) about 40-48% zinc by weight, about 51-58% aluminum by weight, about 1-2% silicon by weight, about 0.1-1% iron by weight and <about 1% titanium by weight or 3) about 70-90% zinc and about 10-30% nickel by weight.

8. The faux stainless steel sheet of claim 1 wherein the polished coating has a surface roughness in the range of about 8-48 RA microinches, scratches having a length in the range of about ⅛ inches to about ⅜ inches, and a reflectivity of about 38 to 360 gloss units.

9. The faux stainless steel sheet of claim 1 wherein the polished surface has a reflectivity in one of the ranges of about 38-48 gloss units, 120-130 gloss units and 355-360 gloss units wherein a gloss unit is the ratio of light specularly reflected to the total light reflected wherein specularly reflected light is one wherein the angle of incidence equals the angle of reflection.

10. The faux stainless steel sheet of claim 1 wherein the polished surface has scratches having lengths in one of the ranges of about ¼ to about ⅜ inches, about ⅜ to ½ inch, about ⅛ to about 3/16 inches, and about 3/16 to about ¼ inches.

11. The faux stainless steel sheet of claim 1 wherein the coating has a polished surface roughness Ra in the range of about 8 to 48 microinches.

12. The faux stainless steel sheet of claim 1 wherein the coating has a thickness of about 0.0002 to about 0.0010 inches.

13. The faux stainless steel sheet of claim 1 wherein the coating finish has a polished faux stainless steel finish comprising 120-150 mesh wherein the term mesh refers to a belt grit value.

14. The faux stainless steel sheet of claim 1 wherein the coating finish has a plurality of scratches having a length in the range of about ⅛ inches to about ⅜ inches.

15. (canceled)

16. (canceled)

17. A method of producing a faux stainless steel sheet comprising coating a sheet material with a metal and then polishing the metal coating with an abrasive grit to simulate a stainless steel finish.

18. (canceled)

19. The method of claim 17 wherein the sheet material is metal.

20. The method of claim 19 wherein the sheet material is steel.

21. The method of claim 19 wherein the sheet material is carbon steel.

22. The method of claim 17 wherein the sheet material is a non-metal.

23. The method of claim 17 including polishing the coating to a #4 abraded stainless steel finish.

24. The method of claim 17 wherein the coating forming step comprises forming the coating with an alloy selected from the group consisting of 1) about 80% zinc by weight and about 20% aluminum by weight, 2) about 40-48% zinc by weight, about 51-58% aluminum by weight, about 1-2% silicon by weight, about 0.1-1% iron by weight and <about 1% titanium by weight or 3) about 70-90% zinc by weight and about 10-30% nickel by weight.

25. The method of claim 17 wherein the coating forming step comprises forming the coating with an alloy of zinc having a composition in the range of about 40% to about 90% zinc by weight and aluminum and nickel in the range of 20 to 58% aluminum by weight and 10-30% nickel by weight.

26. The method of claim 17 wherein the coating forming step comprises depositing the coating on the sheet material to a thickness of about 0.0007 to about 0.0015 inches and then polishing the coating to a thickness of about 0.0002 to about 0.0010 inches.

27. The method of producing a faux stainless steel sheet of claim 17 wherein the sheet of material is a sheet of carbon steel material and the coating comprises an aluminum-zinc or aluminum-nickel alloy and the polishing step comprises polishing the alloy coating with at least one abrasive grit belt to simulate a stainless steel finish.

28. (canceled)

29. The method of claim 27 wherein the method includes conveying the sheet steel material past the at least one abrasive grit belt at a speed in the range of about 80 ft./min. to about 150 ft./min.

30. The method of claim 27 wherein the method includes sequentially polishing the sheet steel material with a plurality of two roll rotatable polishing heads for driving a corresponding plurality of sequentially positioned polishing abrasive grit belts, the rolls of the two roll heads rotating in the range of about 900 to about 1860 RPM.

31. The method of claim 30 comprising at least two of said two roll heads for polishing the material.

32. The method of claim 27 wherein the method includes sequentially polishing the sheet steel material with a plurality of four roll rotatable polishing heads for driving a corresponding plurality of sequentially positioned polishing abrasive grit belts, the rolls of the four roll heads rotating in the range of about 1140 to about 1893 RPM.

33. The method of claim 32 comprising polishing the sheet steel material with three of said four roll heads.

34. The method of claim 30 including applying a head pressure load % meter amperage current in the range of about 55% to about 60% on each head.

35. The method of claim 32 including applying a head pressure load % meter amperage current in the range of about 60% to about 70% on each head.

36. The method of claim 30 including transversely oscillating at least one of the rolls of each head.

37. The method of claim 32 including transversely oscillating at least one of the rolls of each head.

38. A faux polished stainless steel sheet comprising:
a sheet material;
a metal coating on a surface of the sheet material; and
a polished finish on the exterior surface of the metal coating, which finish simulates polished stainless steel;
the polished coating having a surface roughness in the range of about 8-48 Ra microinches, scratches having a length in the range of about ⅛ inches to about ⅜ inches, and a reflectivity of about 38 to 360 gloss units.

39. A faux polished stainless steel sheet comprising:
a sheet material;
a metal coating on a surface of the sheet material;
a polished finish on the exterior surface of the metal coating, which finish simulates polished stainless steel; and
the polished surface has a reflectivity in one of the ranges of about 38-48 gloss units, 120-130 gloss units and 355-360 gloss units wherein a gloss unit is the ratio of light specularly reflected to the total light reflected wherein specularly reflected light is one wherein the angle of incidence equals the angle of reflection.

40. A faux polished stainless steel sheet comprising:
a sheet material;
a metal coating on a surface of the sheet material;
a polished finish on the exterior surface of the metal coating, which finish simulates polished stainless steel; and
the polished surface has scratches having lengths in one of the ranges of about ¼ to about ⅜ inches, about ⅜ to ½ inch, about ⅛ to about 3/16 inches and about 3/16 to about ¼ inches.
